(19) United States
(12) Patent Application Publication
(10) Pub. No.: US 2023/0405729 A1
(43) Pub. Date: Dec. 21, 2023

(54) IMAGING HEAD, CONTROL SYSTEM, AND PROCESSING SYSTEM

(71) Applicant: NIKON CORPORATION, Tokyo (JP)

(72) Inventors: Toshimitsu KURAMI, Saitama-shi (JP); Koichi YASUBA, Fukaya-shi (JP)

(73) Assignee: NIKON CORPORATION, Tokyo (JP)

(21) Appl. No.: 18/036,780

(22) PCT Filed: Nov. 18, 2020
(86) PCT No.: PCT/JP2020/042954

§ 371 Date: May 12, 2023

(51) Int. Cl. B23K 26/70; B23K 26/354

(52) U.S. Cl. CPC B23K 26/70; B23K 26/354

(57) ABSTRACT

An imaging head includes: a deflection optical system configured to deflect light from at least a part of a melt pool part, the melt pool part is formed on the object by an irradiation with a processing beam from the processing head; an imaging apparatus configured to optically receive the light deflected by the deflection optical system to capture an image of at least a part of the melt pool part; and a supply unit configured to supply gas from a gas supply apparatus to at least a part of an optical surface of the deflection optical system.

### TECHNICAL FIELD

The present invention relates to a technical field of an imaging head, a control system, and a processing system for processing an object.

### BACKGROUND ART

A Patent Literature 1 discloses one example of a processing system that processes an object. One technical problem of this type of processing system is to process the object properly.

### CITATION LIST

### Patent Literature

Patent Literature 1: US2016/0375521A1

### SUMMARY OF INVENTION

A first aspect provides an imaging head that is attachable to a processing head, the processing head being configured to process an object, the imaging head including: a deflection optical system configured to deflect light from at least a part of a melt pool part, the melt pool part being formed on the object by an irradiation with a processing beam from the processing head; an imaging apparatus configured to optically receive the light deflected by the deflection optical system to capture an image of at least a part of the melt pool part; and a supply unit configured to supply gas from a gas supply apparatus to at least a part of an optical surface of the deflection optical system.

A second aspect provides an imaging head that is attachable to a processing head of a processing apparatus, the processing apparatus being configured to process an object, the imaging head including: an imaging apparatus configured to capture an image of at least a part of a melt pool part, the melt pool part being formed on the object by an irradiation with a processing beam from the processing head; and a housing in which a containing space for containing the imaging apparatus is formed and in which a supply port for supplying gas, which is the same type as gas supplied to an environment of the processing apparatus from a gas supply apparatus, to the containing space is formed.

A third aspect provides a processing system configured to process an object by irradiating the object with a processing beam, the processing system including: an irradiation optical system configured to irradiate the object with the processing beam; an imaging apparatus configured to generate an object image by capturing an image of at least a part of a melt pool part, the melt pool part being formed on the object by an irradiation with the processing beam from the irradiation optical system; a change apparatus configured to change a relative position of a beam irradiation position relative to the object, the beam irradiation position being irradiated with the processing beam on the object; a characteristic information generation apparatus configured to generate, based on the object image and information related to a direction in which the relative position is changed by the change apparatus, characteristic information related to a characteristic of the melt pool part; and a control apparatus configured to control a characteristic of the processing beam based on the characteristic information.

A fourth aspect provides a processing system configured to process an object by irradiating the object with a processing beam, the processing system including: an irradiation optical system configured to irradiate the object with the processing beam; an imaging apparatus configured to generate an object image by capturing an image of at least a part of a melt pool part, the melt pool part being formed on the object by an irradiation with the processing beam from the irradiation optical system; a change apparatus configured to change a relative position of a beam irradiation position relative to the object, the beam irradiation position being irradiated with the processing beam on the object; a control apparatus configured to correct the object image based on information related to a direction in which the relative position is changed by the change apparatus; and a display apparatus configured to display the object image.

A fifth aspect provides a processing system configured to process an object by irradiating the object with a processing beam, the processing system including: an irradiation optical system configured to irradiate the object with the processing beam; a plurality of imaging apparatuses each of which is configured to generate an object image by capturing an image of at least a part of a melt pool part, the melt pool part being formed on the object by an irradiation with the processing beam from the irradiation optical system; a change apparatus configured to change a relative position of a beam irradiation position relative to the object, the beam irradiation position being irradiated with the processing beam on the object; a characteristic information generation apparatus configured to generate, based on the object image generated by at least one of the plurality of imaging apparatuses and information related to a direction in which the relative position is changed by the change apparatus, characteristic information related to a characteristic of the melt pool part; and a control apparatus configured to control a characteristic of the processing beam based on the characteristic information.

A sixth aspect provides a processing system configured to process an object by irradiating the object with a processing beam, the processing system including: an irradiation optical system configured to irradiate the object with the processing beam; an imaging apparatus configured to generate an object image by capturing an image of at least a part of a melt pool part, the melt pool part being formed on the object by an irradiation with the processing beam from the irradiation optical system; a first change apparatus configured to change a relative position of a beam irradiation position relative to the object, the beam irradiation position being irradiated with the processing beam on the object; a second change apparatus configured to change a position of the imaging apparatus based on information related to a direction in which the relative position is changed by the first change apparatus; a characteristic information generation apparatus configured to generate, based on the object image generated by the imaging apparatus at a position changed by the second change apparatus, characteristic information related to a characteristic of the melt pool part; and a control apparatus configured to control a characteristic of the processing beam based on the characteristic information.

A seventh aspect provides a control system that is attachable to a processing system and that is configured to control the processing system, the processing system being configured to process an object by irradiating the object with a processing beam and supplying a build material to a part that is irradiated with the processing beam, the control system including: an imaging apparatus configured to generate an object image by capturing an image of at least a part of a melt pool part, the melt pool part being formed on the object by an irradiation with the processing beam; an input port that is connectable to the processing system and to which a first control signal is allowed to be inputted from the processing system; a signal generation apparatus configured to generate, based on the object image and the first control signal, a second control signal for controlling a characteristic of the processing beam; and an output port that is connectable to the processing system and that is configured to output the second control signal,

the signal generation apparatus being configured to generate a plurality of second control signals having a plurality of different signal forms, the output port outputting the second control signal having a signal form that is usable by the processing system connected to the output port.

An eighth aspect provides an imaging head that is attachable to a processing head, the processing head being configured to process an object, the imaging head including: a deflection optical system configured to deflect light from the object; an imaging apparatus configured to optically receive the light deflected by the deflection optical system to capture an image of at least a part of the object.

A ninth aspect provides an imaging head that is attachable to a processing head, the processing head being configured to process an object, the imaging head including: an imaging apparatus configured to capture an image of at least a part of a melt pool part, the melt pool part being formed on the object by an irradiation with a processing beam from the processing head; and a housing in which a containing space for containing the imaging apparatus is formed and in which a supply port for supplying gas from a gas supply apparatus to the containing space is formed.

A tenth aspect provides an imaging head that is attachable to a processing head, the processing head being configured to process an object, the imaging head including: an imaging apparatus configured to capture an image of at least a part of a melt pool part, the melt pool part being formed on the object by an irradiation with a processing beam from the processing head; and a supply part configured to supply, to a desired optical surface of the imaging head, gas from a gas supply apparatus.

An eleventh aspect provides a control system that is attachable to a processing system and that is configured to control the processing system, the processing system being configured to process an object by irradiating the object with a processing beam, the control system including: a detection apparatus configured to optically receive light from at least a part of a melt pool part, the melt pool part being formed on the object by an irradiation with the processing beam; a signal generation apparatus configured to generate, based on a detected result by the detection apparatus, a control signal for controlling a characteristic of the processing beam; and an output port that is connectable to the processing system and that is configured to output the control signal.

A twelfth aspect provides a processing system configured to process an object by irradiating the object with a processing beam, the processing system including: an irradiation optical system configured to irradiate the object with the processing beam; a detection apparatus configured to optically receive light from at least a part of a melt pool part, the melt pool part being formed on the object by an irradiation with the processing beam from the irradiation optical system; a characteristic information generation apparatus configured to generate, based on a detected result by the detection apparatus and processing information related to a processing of the object, characteristic information related to a characteristic of the melt pool part; and a control apparatus configured to control a characteristic of the processing beam based on the characteristic information.

A thirteenth aspect provides a processing system configured to process an object by irradiating the object with a processing beam, the processing system including: an irradiation optical system configured to irradiate the object with the processing beam; a detection apparatus configured to optically receive light from at least a part of a melt pool part, the melt pool part being formed on the object by an irradiation with the processing beam from the irradiation optical system; and a display apparatus configured to correct and display a detected result by the detection apparatus based on processing information related to a processing of the object.

A fourteenth aspect provides a processing system configured to process an object by irradiating the object with a processing beam, the processing system including: an irradiation optical system configured to irradiate the object with the processing beam; a plurality of detection apparatuses each of which is configured to optically receive light from at least a part of a melt pool part, the melt pool part being formed on the object by an irradiation with the processing beam from the irradiation optical system; and a characteristic information generation apparatus configured to generate, based on a detected result by at least one of the plurality of detection apparatuses and processing information related to a processing of the object, characteristic information related to a characteristic of the melt pool part; and a control apparatus configured to control a characteristic of the processing beam based on the characteristic information.

A fifteenth aspect provides a processing system configured to process an object by irradiating the object with a processing beam, the processing system including: an irradiation optical system configured to irradiate the object with the processing beam; a detection apparatus configured to optically receive light from at least a part of a melt pool part, the melt pool part being formed on the object by an irradiation with the processing beam from the irradiation optical system; a change apparatus configured to change a position of the imaging apparatus based on processing information related to a processing of the object; a characteristic information generation apparatus configured to generate, based on the detected result by the detection apparatus at a position changed by the change apparatus, characteristic information related to a characteristic of the melt pool part; and a control apparatus configured to control a characteristic of the processing beam based on the characteristic information.

An operation and other advantage of the present invention will be described in a below-described example embodiment.

### BRIEF DESCRIPTION OF DRAWINGS

FIG. 1 is a cross-sectional view that illustrates a configuration of a processing system in a present example embodiment.

FIG. 2 is a system configuration diagram that illustrates a system configuration of the processing system in the present example embodiment.

FIG. 3 is a cross-sectional view that illustrates a configuration of a processing head in the present example embodiment.

FIG. 4 Each of FIG. 4A to FIG. 4E is a cross-sectional view that illustrates an aspect in which a certain area on a workpiece is irradiated with a processing light and build materials are supplied thereto.

FIG. 5 Each of FIG. 5A to FIG. 5C is a cross-sectional view that illustrates a process for forming a three-dimensional structural object.

FIG. 6 is a cross-sectional view that illustrates one example of a configuration of a control system in the present example embodiment.

FIG. 7 is a system configuration diagram that illustrates one example of a system configuration of the control system in the present example embodiment.

FIG. 8 is a cross-sectional view that illustrates one example of a configuration of the control system attached to the processing system.

FIG. 9 is a system configuration diagram that illustrates one example of a system configuration of the control system attached to the processing system.

FIG. 10 illustrates an example in which each of the control system and the processing system includes an input and output connector that is a D-sub connector having 9 pins.

FIG. 11 illustrates an example in which each of the control system and the processing system includes an input and output connector that is a D-sub connector having 9 pins.

FIG. 12 is a flowchart that illustrates a flow of an operation of the control system.

FIG. 13 illustrates one example of a workpiece image.

FIG. 14A is a cross-sectional view that illustrates an imaging apparatus that captures an image of a melt pool in a situation where a build object extending in a Y-axis direction is formed while moving a target irradiation area toward a −Y-axis direction, FIG. 14B is a cross-sectional view that illustrates the imaging apparatus that captures the image of the melt pool in a situation where the build object extending in the Y-axis direction is formed while moving the target irradiation area toward a +Y-axis direction, FIG. 14C illustrates the workpiece image generated by the imaging apparatus in the situation illustrated in FIG. 14A, and FIG. 14D illustrates the workpiece image generated by the imaging apparatus in the situation illustrated in FIG. 14B.

FIG. 15 illustrates one example of a relationship between a moving direction of the target irradiation area and a correction coefficient in a case where the imaging position captures the image of the melt pool from a position that is away from the workpiece toward the −Y side.

FIG. 16 illustrates a GUI for setting the correction coefficient.

FIG. 17 illustrates the melt pool appearing in the workpiece image.

FIG. 18 illustrates a display that displays an image of a three-dimensional structural object ST in a display manner by which applied correction coefficients are distinguishable from each other.

FIG. 19A is a cross-sectional view that illustrates the imaging apparatus that captures the image of the melt pool in a situation where a placement surface is perpendicular to an optical axis (namely, an angle of a stage is 90 degree), FIG. 19B is a cross-sectional view that illustrates the imaging apparatus that captures the image of the melt pool in a situation where the placement surface is inclined with respect to the optical axis (namely, the angle of the stage is smaller than 90 degree), FIG. 19C illustrates the workpiece image generated by the imaging apparatus in the situation illustrated in FIG. 19A, and FIG. 19D illustrates the workpiece image generated by the imaging apparatus in the situation illustrated in FIG. 19B.

FIG. 20 illustrates one example of a relationship between the angle of the stage and the correction coefficient.

FIG. 21A is a cross-sectional view that illustrates the imaging apparatus that captures the image of the melt pool in a situation where one build object extending in a X-axis direction is formed while moving the target irradiation area along the X-axis direction, FIG. 21B is a cross-sectional view that illustrates the imaging apparatus that captures the image of the melt pool in a situation where another build object extending in the X-axis direction is formed at the +Y side of the one build object extending along the X-axis direction while moving the target irradiation area along the X-axis direction, FIG. 21C illustrates the workpiece image generated by the imaging apparatus in the situation illustrated in FIG. 21A, and FIG. 21D illustrates the workpiece image generated by the imaging apparatus in the situation illustrated in FIG. 21B.

FIG. 22 illustrates the display that displays the workpiece image that has been corrected.

FIG. 23 illustrates the display that displays the workpiece image that has been corrected together with the workpiece image that has not been corrected.

FIG. 24 is a system configuration diagram that illustrates one example of a system configuration of a control system in a third modified example.

FIG. 25 is a cross-sectional view that illustrates the imaging apparatus that captures the image of the melt pool when the build object extending in the Y-axis direction is formed while moving the target irradiation area toward the −Y-axis direction.

FIG. 26 is a cross-sectional view that illustrates the imaging apparatus that captures the image of the melt pool when the build object extending in the Y-axis direction is formed while moving the target irradiation area toward the +Y-axis direction.

FIG. 27 is a system configuration diagram that illustrates one example of a system configuration of a control system in a sixth modified example.

FIG. 28 Each of FIG. 28A and FIG. 28B is a cross-sectional view that illustrates the imaging apparatus and a mirror.

FIG. 29 is a cross-sectional view that illustrates the imaging apparatus that captures the image of the melt pool when the build object extending in the Y-axis direction is formed while moving the target irradiation area toward the −Y-axis direction.

FIG. 30 is a cross-sectional view that illustrates the imaging apparatus that captures the image of the melt pool when the build object extending in the Y-axis direction is formed while moving the target irradiation area toward the +Y-axis direction.

### DESCRIPTION OF EXAMPLE EMBODIMENTS

Next, with reference to drawings, an embodiment of an imaging head, a control system, and a processing system will be described. In the below-described description, the embodiment of the imaging head, the control system, and the processing system will be described by using a processing system that is configured to perform an additive processing on a workpiece W that is one example of an object. Especially, in the below-described description, the embodiment of the imaging head, the control system, and the processing system will be described by using the processing system that is configured to perform the additive processing based on a Laser Metal Deposition (LMD). The additive processing based on the Laser Metal Deposition is an additive processing that melts a build material M supplied to the workpiece by processing light EL (namely, an energy in a form of light) to form a three-dimensional structural object ST that is integrated with or separatable from the workpiece W.

Note that the Laser Metal Deposition may be referred to as a Direct Metal Deposition, a Direct Energy Deposition, a Laser Cladding, a Laser Engineered Net Shaping, a Direct Light Fabrication, a Laser Consolidation, a Shape Deposition Manufacturing, a Wire Feed Laser Deposition, a Gas Through Wire, a Laser Powder Fusion, a Laser Metal Forming, a Selective Laser Powder Re-melting, a Laser Direct Casting, a Laser Powder Deposition, a Laser Additive Manufacturing or a Laser Rapid Forming.

Moreover, in the below-described description, a positional relationship of various components included in the processing system SYS will be described by using an XYZ rectangular coordinate system that is defined by a X-axis, a Y-axis and a Z-axis that are perpendicular to one another. Note that each of an X-axis direction and a Y-axis direction is assumed to be a horizontal direction (namely, a predetermined direction in a horizontal plane) and a Z-axis direction is assumed to be a vertical direction (namely, a direction that is perpendicular to the horizontal plane, and substantially a vertical direction) in the below-described description, for convenience of the description. Moreover, rotational directions (in other words, inclination directions) around the X-axis, the Y-axis and the Z-axis are referred to as a θX direction, a θY direction and a θZ direction, respectively. Here, the Z-axis direction may be a gravity direction. Moreover, an XY plane may be a horizontal direction.

### (1) Processing System SYS

### (1-1) Configuration of Processing System SYS

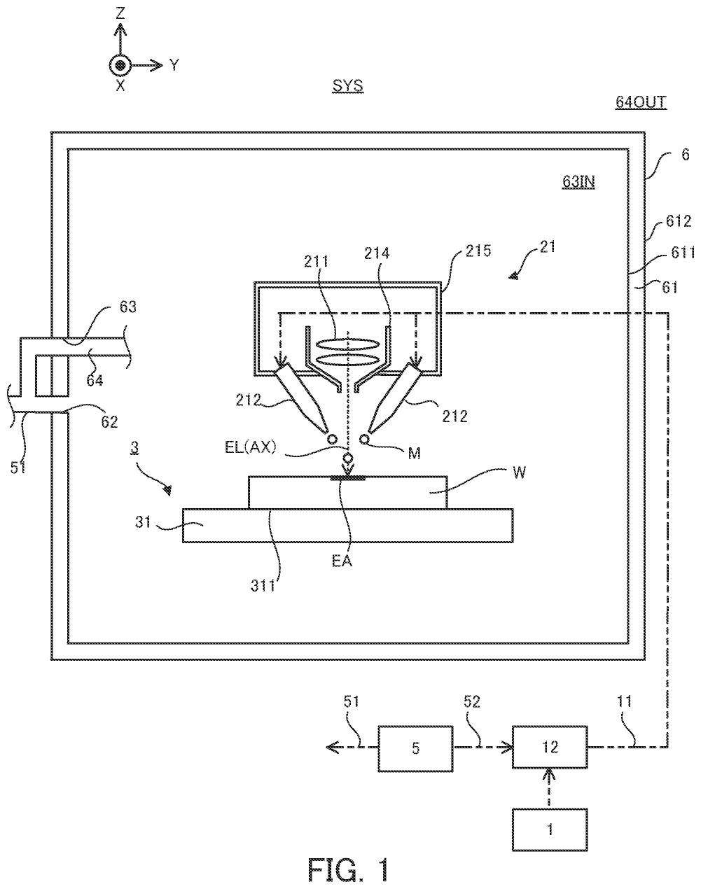

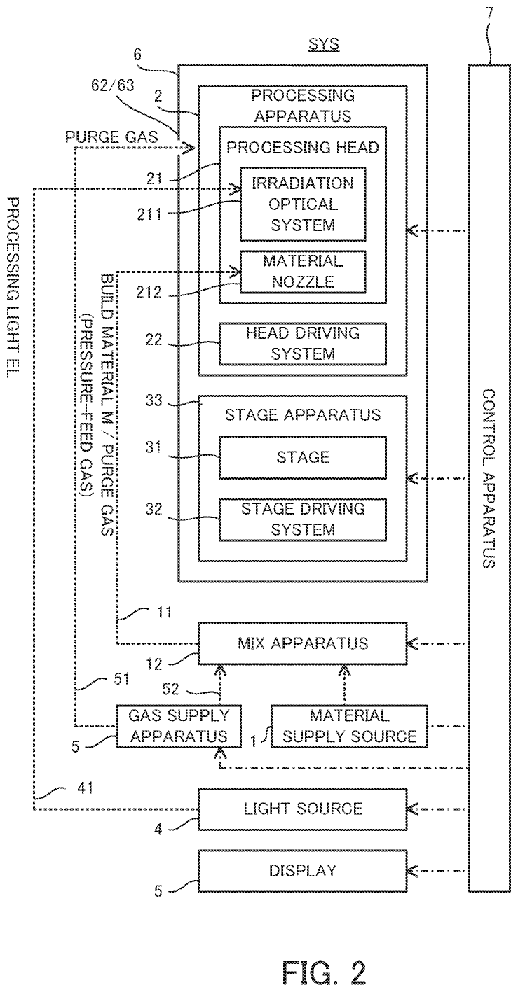

Firstly, with reference to FIG. 1 and FIG. 2, a configuration of the processing system SYS in the present example embodiment will be described. FIG. 1 is a cross-sectional view that illustrates one example of the configuration of the processing system SYS in the present example embodiment. FIG. 2 is a system configuration diagram that illustrates one example of a system configuration of the processing system SYS in the present example embodiment.

The processing system SYS is configured to perform a build operation for forming the three-dimensional structural object ST (namely, a three-dimensional object having a magnitude (a size) in each of three-dimensional directions, a solid object, in other words, an object having a magnitude (a size) in the X-axis direction, the Y-axis direction, and the Z-axis direction). The processing system SYS is configured to form the three-dimensional structural object ST on the workpiece W that is a base (namely, a base member) for forming the three-dimensional structural object ST. The processing system SYS is configured to form the three-dimensional structural object ST by performing the additive processing on the workpiece W. When the workpiece W is a below-described stage 31, the processing system SYS is configured to form the three-dimensional structural object ST on the stage 31. When the workpiece W is an existing object placed on the stage 31 (alternatively, placed on the stage 31), the processing system SYS may be configured to form the three-dimensional structural object ST on the existing object. In this case, the processing system SYS may form the three-dimensional structural object ST that is integrated with the existing object. An operation for forming the three-dimensional structural object ST that is integrated with the existing object is equivalent to an operation for adding a new structural object to the existing object. Note that the existing structural object may be an item that needs to be repaired having a missing part, for example. The processing system SYS may form the three-dimensional structural object ST on the item that needs to be repaired to fill in the missing part of the item that needs to be repaired. Alternatively, the processing system SYS may form the three-dimensional structural object ST that is separable from the existing object. Note that FIG. 1 illustrates an example in which the workpiece W is the existing object held by the stage 31. Moreover, in the below-described description, the example in which the workpiece W is the existing object held by the stage 31 will be described.

As described above, the processing system SYS is configured to form the three-dimensional structural object ST by the Laser Metal Deposition. Namely, it can be said that the processing system SYS is a 3D printer that forms an object by using an Additive layer manufacturing technique. Note that the Additive layer manufacturing technique may be referred to as a Rapid Prototyping, a Rapid Manufacturing or an Additive Manufacturing.

The processing system SYS forms the three-dimensional structural object ST by processing the build material M with the processing light EL. The build material M is a material that is molten by an irradiation with the processing light EL having a predetermined intensity or more intensity. At least one of a metal material and a resin material is usable as the build material M, for example. However, another material that is different from the metal material and the resin material may be used as the build material M. The build materials M are powder-like or grain-like materials. Namely, the build materials M are powdery materials. However, the build materials M may not be the powdery materials. For example, a wired-like build material or a gas-like build material may be used, as the build material M, for example.

In order to perform the build operation for forming the three-dimensional structural object, the processing system SYS includes a material supply source 1, a processing apparatus 2, a stage apparatus 3, a light source 4, a gas supply apparatus 5, a housing 6, a control apparatus 7, and a display 9, as illustrated in FIG. 1 and FIG. 2. At least a part of each of the processing apparatus 2 and the stage apparatus 3 may be contained in a chamber space 63IN in the housing 6.

The material supply source 1 is configured to supply the build materials M to the processing apparatus 2. The material supply source 1 supplies, to the processing apparatus 2, the build materials M the amount of which is necessary for forming the three-dimensional structural object ST per unit time by supplying the build materials M the amount of which is based on the necessary amount.

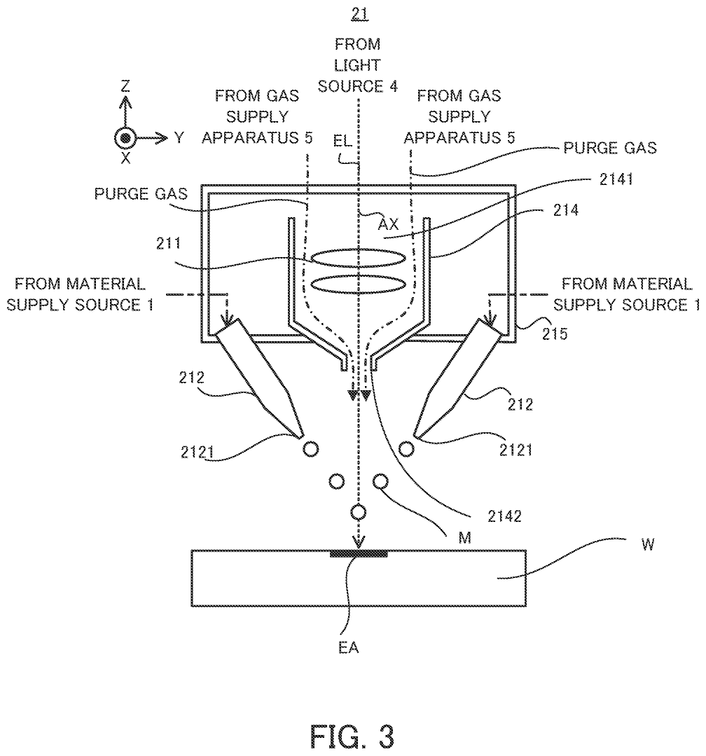

The processing apparatus 2 forms the three-dimensional structural object ST by processing the build materials M supplied from the material supply source 1. In order to form the three-dimensional structural object ST, the processing apparatus 2 include a processing head 21 that is configured to process the workpiece W and a head driving system 22 that is configured to move the processing head 21. Furthermore, the processing head 21 includes an irradiation optical system (an irradiation system) 211 and a material nozzle 212. Incidentally, in the below-described description related to the processing head 21, not only FIG. 1 and FIG. 2 but also FIG. 3 that is a cross-sectional view illustrating a configuration of the processing head 21 are used. The processing head 21 and the head driving system 22 are contained in the chamber space 63IN. However, at least a part of the processing head 21 may be disposed in an external space 64OUT that is a space outside the housing 6. At least a part of the head driving system 22 may be disposed in the external space 64OUT. Note that the external space 64OUT may be a space into which an operator of the processing system SYS is allowed to enter.

The irradiation optical system 211 is an optical system for emitting the processing light EL. Specifically, the irradiation optical system 211 is optically connected to the light source 4 that generates the processing light EL through a light transmitting member 41 such as an optical fiber and a light pipe. The irradiation optical system 211 emits the processing light EL transmitted from the light source 4 through the light transmitting member 41. The irradiation optical system 211 emits the processing light EL in a downward direction (namely, toward a −Z side) from the irradiation optical system 211. Thus, an optical axis AX of the irradiation optical system 211 may be an axis along the Z-axis. The stage 31 is disposed below the irradiation optical system 211. When the workpiece W is placed on the stage 31, the irradiation optical system 211 emits the processing light EL toward the workpiece W that is the object. Specifically, the irradiation optical system 211 is configured to irradiate a target irradiation area EA, which is set on the workpiece W or near the workpiece W as an area that is irradiated with the processing light EL (typically, in which the light is condensed), with the processing light EL. Namely, the irradiation optical system 211 irradiates an position at which the target irradiation area EA is set with the processing light EL. Furthermore, a state of the irradiation optical system 211 is switchable between a state where the target irradiation area EA is irradiated with the processing light EL and a state where the target irradiation area EA is not irradiated with the processing light EL under the control of the control apparatus 7. Note that a direction of the processing light EL emitted from the irradiation optical system 211 is not limited to a direct downward direction (namely, coincident with the −Z-axis direction), and may be a direction that is inclined with respect to the Z-axis by a predetermined angle, for example.

The irradiation optical system 211 is contained in an internal space 2141 of a barrel 214. Namely, the barrel 214 contains the irradiation optical system 211 in its internal space 2141. Thus, the barrel 214 may be referred to as a containing member. The barrel 214 may hold the irradiation optical system 211 contained in the internal space 2141. An emission port 2142, which is an aperture through which the processing light EL emitted from the irradiation optical system 211 is allowed to be emitted, is formed at the barrel 214. Thus, the irradiation optical system 211 emits the processing light EL from an inside of the barrel 214 toward an outside of the barrel 214 through the emission port 2142.

The barrel 214 is further contained in a head housing 215. In this case, the irradiation optical system 211 may be regarded to be contained in the head housing 215. Thus, the head housing 215 may be referred to as a containing member. The barrel 214 is disposed so that at least the emission port 2142 is exposed to the outside of the head housing 215. As a result, even when the barrel 214 is contained in the head housing 215, the irradiation optical system 211 is capable of emitting the processing light EL toward the outside of the barrel 214 (furthermore, the outside of the head housing 215) through the emission port 2142. Note that the head housing 215 may be integrated with the barrel 214. Alternatively, the processing head 21 may not include the head housing 215. In this case, the barrel 214 may be used as the head housing 215.

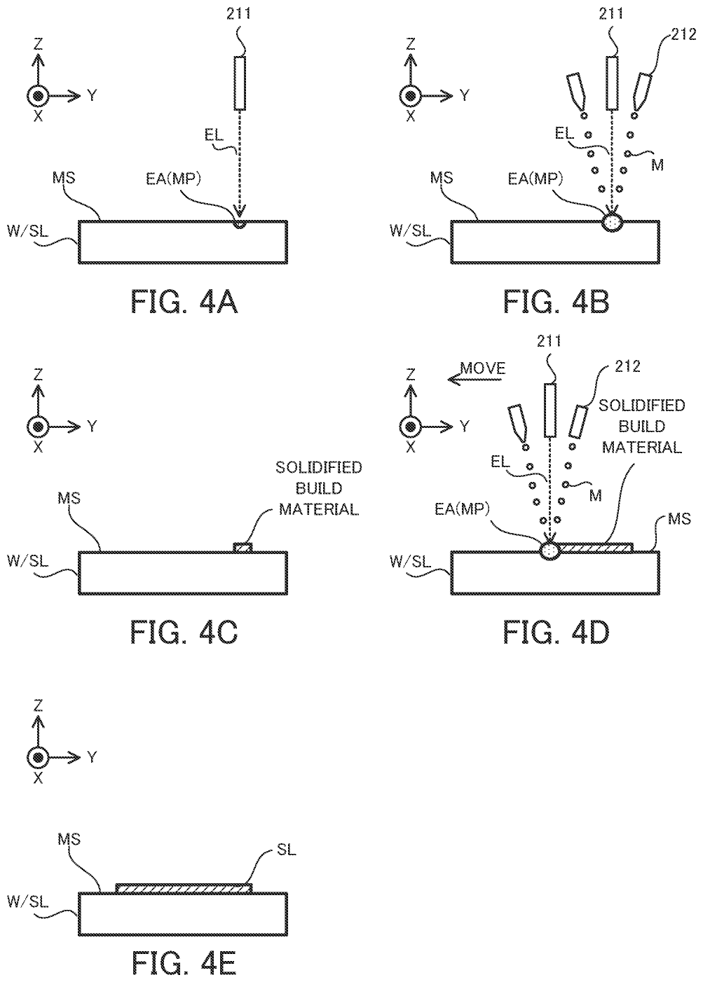

The material nozzle 212 is attached to the head housing 215. In an example illustrated in FIG. 1 and FIG. 4, two material nozzles 212 are attached to the head housing 215. However, single material nozzle 212 may be attached to the head housing 215, and three or more material nozzles 212 may be attached to the head housing 215. Incidentally, when the processing head 21 does not include the head housing 215, the material nozzle 212 may be attached to the barre. 214 (alternatively, any support member).

A material supply port 2121, which is an aperture, is formed at the material nozzle 212. The material nozzle 212 supplies (for example, injects, jets, blows out or sprays) the build materials M from the material supply port 2121. The material nozzle 212 is physically connected to the material supply source 1, which is a supply source of the build materials M, through a supply pipe 11 and a mix apparatus 12. The material nozzle 212 supplies the build materials M supplied from the material supply source 1 through the supply pipe 11 and the mix apparatus 12. The material nozzle 212 may pressure-feed the build materials M supplied from the material supply source 1 through the supply pipe 11. Namely, the build materials M from the material supply source 1 and a gas for feeding (namely, a pressure-feed gas, and an inert gas such as a Nitrogen or an Argon, for example) may be mixed by the mix apparatus 12 and then pressure-fed to the material nozzle 212 through the supply pipe 11. As a result, the material nozzle 212 supplies the build materials M together with the gas for feeding. Purge gas supplied from the gas supply apparatus 5 is used as the gas for feeding, for example. However, a gas supplied from a gas supply apparatus that is different from the gas supply apparatus 5 may be used as the gas for feeding. Note that the material nozzle 212 is illustrated to have a tube-like shape in FIG. 1 and FIG. 3, however, a shape of the material nozzle 212 is not limited to this shape.

The gas used to supply the build materials M from the material nozzle 212 may be used to prevent oxidation of the build materials M. For example, Nitrogen and Argon used as the gas for supplying the build materials M from the material nozzle 212 may be used to prevent the oxidation of build materials M. Moreover, the gas used to supply the build materials M from the material nozzle 212 may be used to prevent nitriding of the build materials M. For example, the Argon, which is used as the gas for supplying the build materials M from the material nozzle 212, may be used to prevent the nitriding of the build materials M.

The material nozzle 212 supplies the build materials M in a downward direction (namely, toward the −Z side) from the material nozzle 212. The stage 31 is disposed below the material nozzle 212. When the workpiece W is placed on the stage 31, the material nozzle 212 supplies the build materials M toward the workpiece W or a vicinity of the workpiece W. Note that a supply direction of the build materials M supplied from the material nozzle 212 is a direction that is inclined with respect to the Z-axis by a predetermined angle (as one example, an acute angle), however, it may be the −Z-axis direction (namely, a direct downward direction).

The material nozzle 212 supplies the build materials M to an area that is irradiated with the processing light EL from the irradiation optical system 211 (namely, the processing light EL from the processing head 21). Namely, the material nozzle 212 supplies the build materials M to the target irradiation area EA. Thus, the build materials M supplied from the material nozzle 212 is irradiated with the processing light EL emitted from the irradiation optical system 211. As a result, the build materials M are molten. The processing system SYS performs the additive processing on the workpiece W by using the molten build materials M.

The head driving system 22 is configured to move the processing head 21. The head driving system 22 moves the processing head 21 along at least one of the X-axis, the Y-axis, the Z-axis, the θX direction, the θY direction and the θZ direction, for example. Since the processing head 21 includes the irradiation optical system 211 and the material nozzle 212, when the head driving system 22 moves the processing head 21, the irradiation optical system 211 and the material nozzle 212 also move. Thus, the head driving system 22 may be regarded to be a driving system that is configured to move the irradiation optical system 211 and the material nozzle 212 simultaneously.

When the head driving system 22 moves the processing head 21, a positional relationship between the processing head 21 and each of the stage 31 and the workpiece W supported by the stage 31 changes. As a result, a relative position of the target irradiation area EA, which corresponds to a beam irradiation position that is irradiated with the processing light EL on the workpiece W, relative to the workpiece W (in other words, a positional relationship between the target irradiation area EA and the workpiece W) changes. Namely, the target irradiation area EA moves on the workpiece W. Thus, the head driving system 22 may be referred to as a change apparatus that is configured to change the relative position of the target irradiation area EA relative to the workpiece W. The head driving system 22 may be referred to as a movement apparatus that is configured to movie the target irradiation area EA on the workpiece W.

The stage apparatus 3 includes the stage 31. The stage 31 is contained in the chamber space 63IN. The workpiece W is allowed to be placed on a placement surface 311 that is at least a part of a surface of the stage 31. The stage 31 may be configured to hold the workpiece W placed on the stage 31. In this case, the stage 31 may include at least one of a mechanical chuck, an electro-static chuck, a vacuum chuck and the like in order to hold the workpiece W. Alternatively, the stage 31 may not be configured to hold the workpiece W placed on the stage 31. In this case, the workpiece W may be placed on the stage 31 without clamp. Since the stage 31 is contained in the chamber space 63IN, the workpiece W supported by the stage 31 is also contained in the chamber space 63IN. Furthermore, the stage 31 may be configured to release the held workpiece W, when the workpiece W is held. The above-described irradiation optical system 211 emits the processing light EL in at least a part of a period during which the workpiece W is placed on the stage 31. Furthermore, the above-described material nozzle 212 supplies the build materials M in at least a part of the period during which the workpiece W is placed on the stage 31

The stage driving system 32 is configured to move (namely, displace) the stage 31. The stage driving system 32 moves the stage 31 along at least one of the X-axis, the Y-axis, the Z-axis, the θX direction, the θY direction and the θZ direction, for example. When the stage driving system 32 moves the stage 31, the positional relationship between the processing head 21 and each of the stage 31 and the workpiece W supported by the stage 31 changes. As a result, the relative position of the target irradiation area EA relative to the workpiece W (in other words, the positional relationship between the target irradiation area EA and the workpiece W) changes. Namely, the target irradiation area EA moves on the workpiece W. Thus, the stage driving system 32 may be referred to as the change apparatus that is configured to change the relative position of the target irradiation area EA relative to the workpiece W or the movement apparatus that is configured to movie the target irradiation area EA on the workpiece W, as with the head driving system 22.

The light source 4 is configured to emit at least one of an infrared light, a visible light and an ultraviolet light as the processing light EL, for example. However, other type of light may be used as the processing light EL. The processing light EL may include a plurality of pulsed lights (namely, a plurality of pulsed beams). The processing light EL may include a Continuous Wave (CW). The processing light EL may be a laser light. In this case, the light source 4 may include semiconductor laser such as a laser light source (for example, a Laser Diode (LD)). The laser light source may include at least one of a fiber laser, a CO₂ laser, a YAG laser, an Excimer laser and the like. However, the processing light EL may not be the laser light. The light source 4 may include any light source (for example, at least one of a LED (Light Emitting Diode), a discharge lamp and the like).

The gas supply apparatus 5 is a supply source of purge gas for purging the chamber space 63IN. The purge gas includes inert gas. At least one of Nitrogen gas and Argon gas is one example of the inert gas. The gas supply apparatus 5 is connected to the chamber space 63IN through a supply port 62 formed at a wall member 61 of the housing 6 and a supply pipe 51 that connects the gas supply apparatus 5 and the supply port 62. The gas supply apparatus 5 supplies the purge gas to the chamber space 63IN through the supply pipe 51 and the supply port 62. As a result, the chamber space 63IN is a space that is purged by the purge gas. The purge gas supplied to the chamber space 63IN may be discharged from a non-illustrated discharge port formed at the wall member 61. Note that the gas supply apparatus 5 may be a tank that stores the inert gas. When the purge gas is the Nitrogen gas, the gas supply apparatus 5 may be a Nitrogen gas generation apparatus that generates the Nitrogen gas by using air as material.

The purge gas from the gas supply apparatus 5 may be supplied to the internal space 2141 of the barrel 214, as illustrated in FIG. 3. Since the irradiation optical system 211 is contained in the internal space 2141, the gas supply apparatus 5 may supply the purge gas to the irradiation optical system 211. The purge gas supplied to the irradiation optical system 211 may be used to cool the irradiation optical system 211. The purge gas supplied to the irradiation optical system 211 may be used to prevent unnecessary substance from adhering to the irradiation optical system 211. The unnecessary substance may include, for example, fume generated by the irradiation of the workpiece W with the processing light EL. The unnecessary substance may include, for example, at least a part of the build materials M supplied from the material nozzle 212 (especially, the build material M that was not used to form the three-dimensional structural object ST).

The purge gas supplied to the irradiation optical system 211 may be discharged from the inside of the barrel 214 to the outside of the barrel 214 through the emission port 2142 of the barrel 214, as illustrated in FIG. 3. At least a part of the purge gas discharged from the barrel 214 may form a flow of the purge gas around the material supply port 2121. At least a part of the purge gas discharged from the barrel 214 may be sprayed onto the material supply port 2121. As a result, there is a lower possibility that the unnecessary substance such as the fume adheres to the material supply port 2121 (furthermore, to the material nozzle 212), compared to a case where the purge gas discharged from the barrel 214 does not form the flow of the purge gas around the material supply port 2121. Thus, the purge gas discharged from the barrel 214 may be used to prevent the unnecessary substance from adhering to the material nozzle 212 and/or to remove the unnecessary substance adhering to the material nozzle 212.

When the material nozzle 212 supplies the build materials M together with the purge gas as described above, the gas supply apparatus 5 may supply the purge gas to the mix apparatus 12 to which the build materials M are supplied from the material supply source 1, in addition to the chamber space 63IN. Specifically, the gas supply apparatus 5 may be connected to the mix apparatus 12 through a supply pipe 52 that connects the gas supply apparatus 5 and the mix apparatus 12. As a result, the gas supply apparatus 5 supplies the purge gas to the mix apparatus 12 through the supply pipe 52. In this case, the build materials M from the material supply source 1 may be supplied (specifically, pressure-fed) to the material nozzle 212 through the supply pipe 11 by the purge gas supplied from the gas supply apparatus 5 through the supply pipe 52. Namely, the gas supply apparatus 5 may be connected to the material nozzle 212 through the supply pipe 52, the mix apparatus 12 and the supply pipe 11. In this case, the material nozzle 212 supplies, from the material supply port 2121, the build materials M together with the purge gas for pressure-feeding the build materials M.

The housing 6 is a housing apparatus that is configured to contain at least a part of each of at least the processing apparatus 2 and the stage apparatus 3 in the chamber space 63IN that is an internal space of the housing 6. The housing 6 includes the wall member 61 that defines the chamber space 63IN. The wall member 61 is a member that separates the chamber space 63IN from the external space 64OUT at the outside of the housing 6. The wall member 61 faces the chamber space 63IN through its inner wall surface 611 and faces the external space 64OUT through its outer wall surface 612. In this case, a space surrounded by the wall member 61 (more specifically, a space surrounded by the inner wall surface 611 of the wall member 61) is the chamber space 63IN. Note that an openable and closable door may be disposed at the wall member 61. The door may be opened when the workpiece W is to be placed on the stage 31. The door may be opened when the workpiece W and/or the three-dimensional structural object ST is unloaded from the stage 31. The door may be closed in a period during which the build operation is performed. Note that an observation window (not illustrated) for visually observing the chamber space 63IN from the external space 64OUT of the housing 6 may be disposed at the wall member 61.

The control apparatus 7 is configured to control an operation of the processing system SYS. The control apparatus 7 may include an arithmetic apparatus and a storage apparatus. The arithmetic apparatus may include at least one of a CPU (Central Processing Unit) and a GPU (Graphic Processing Unit), for example. The storage apparatus may include a memory. The control apparatus 7 serves as an apparatus for controlling the operation of the processing system SYS by means of the arithmetic apparatus executing a computer program. The computer program is a computer program that allows the arithmetic apparatus to execute (namely, to perform) a below-described operation that should be executed by the control apparatus 7. Namely, the computer program is a computer program that allows the control apparatus 7 to function so as to make the processing system SYS execute the below-described operation. The computer program executed by the arithmetic apparatus may be recorded in the storage apparatus (namely, a recording medium) of the control apparatus 7, or may be recorded in any recording medium (for example, a hard disk or a semiconductor memory) that is built in the control apparatus 7 or that is attachable to the control apparatus 7. Alternatively, the arithmetic apparatus may download the computer program that should be executed from an apparatus disposed at the outside of the control apparatus 7 through a network interface.

For example, the control apparatus 7 may control an emitting aspect of the processing light EL by the irradiation optical system 211. The emitting aspect may include at least one of the intensity of the processing light EL and emitting timing of the processing light EL, for example. When the processing light EL includes the pulsed light, the emitting aspect may include at least one of an ON time of the pulsed light, an emission cycle of the pulsed light and a ratio (what we call a duty ratio) of a length of the ON time of the pulsed light and a length of the emission cycle of the pulsed light, for example. Furthermore, the control apparatus 7 may control a moving aspect of the processing head 21 by the head driving system 22. Furthermore, the control apparatus 7 may control a moving aspect of the stage 31 by the stage driving system 32. The moving aspect may include at least one of a moving distance, a moving speed, a moving direction and a moving timing (a moving period), for example. Moreover, the control apparatus 7 may control a supply aspect of the build materials M by the material nozzle 212. The supply aspect may include at least one of the supplied amount (especially, the supplied amount per unit time) and a supply timing (a supply period).

The control apparatus 7 may not be disposed in the processing system SYS. For example, the control apparatus 7 may be disposed at the outside of the processing system SYS as a server or the like. In this case, the control apparatus 7 may be connected to the processing system SYS through a wired and/or wireless network (alternatively, a data bus and/or a communication line). A network using a serial-bus-type interface such as at least one of IEEE1394, RS-232x, RS-422, RS-423, RS-485 and USB may be used as the wired network. A network using a parallel-bus-type interface may be used as the wired network. A network using an interface that is compatible to Ethernet (a registered trademark) such as at least one of 10-BASE-T, 100BASE-TX or 1000BASE-T may be used as the wired network. A network using an electrical wave may be used as the wireless network. A network that is compatible to IEEE802.1x (for example, at least one of a wireless LAN and Bluetooth (registered trademark)) is one example of the network using the electrical wave. A network using an infrared ray may be used as the wireless network. A network using an optical communication may be used as the wireless network. In this case, the control apparatus 7 and the processing system SYS may be configured to transmit and receive various information through the network. Moreover, the control apparatus 7 may be configured to transmit information such as a command and a control parameter to the processing system SYS through the network. The processing system SYS may include a reception apparatus that is configured to receive the information such as the command and the control parameter from the control apparatus 7 through the network. The processing system SYS may include a transmission apparatus that is configured to transmit the information such as the command and the control parameter to the control apparatus 7 through the network (namely, an output apparatus that is configured to output information to the control apparatus 7). Alternatively, a first control apparatus that is configured to perform a part of the arithmetic processing performed by the control apparatus 7 may be disposed in the processing system SYS and a second control apparatus that is configured to perform another part of the arithmetic processing performed by the control apparatus 7 may be disposed at an outside of the processing system SYS.

Note that at least one of an optical disc such as a CD-ROM, a CD-R, a CD-RW, a flexible disc, a MO, a DVD-ROM, a DVD-RAM, a DVD-R, a DVD+R, a DVD-RW, a DVD+RW and a Blu-ray (registered trademark), a magnetic disc such as a magnetic tape, an optical-magnetic disc, a semiconductor memory such as a USB memory, and another medium that is configured to store the program may be used as the recording medium recording therein the computer program that should be executed by the control apparatus 7 may include. Moreover, the recording medium may include a device that is configured to record the computer program (for example, a device for a universal use or a device for an exclusive use in which the computer program is embedded to be executable in a form of at least one of a software, a firmware and the like). Moreover, various arithmetic processing or functions included in the computer program may be realized by a logical processing block that is realized in the control apparatus 7 by means of the control apparatus 7 (namely, a computer) executing the computer program, may be realized by a hardware such as a predetermined gate array (a FPGA, an ASIC) of the control apparatus 7, or may be realized in a form in which the logical process block and a partial hardware module that realizes a partial element of the hardware are combined.

The display 9 is a display apparatus that is configured to display a desired image under the control of the control apparatus 7. The display 9 may include a display of the processing system SYS (namely, a display built into the processing system SYS). The display 9 may include a display that is attachable to the processing system SYS. Alternatively, a display of an apparatus different from the processing system SYS may display the desired image under the control of the control apparatus 7. For example, a display of at least one of a laptop computer and a tablet device may display the desired image under the control of the control apparatus 7. In this case, the processing system SYS may not include the display 9. Alternatively, the processing system SYS may not include the display 9.

### (1-2) Operation of Processing System SYS

Next, an operation of the processing system SYS will be described. As described above, the processing system SYS performs the build operation for forming the three-dimensional structural object ST by performing the additive processing on the workpiece W. Specifically, the processing system SYS forms the three-dimensional structural object ST by the Laser Metal Deposition. Thus, the processing system SYS may form the three-dimensional structural object ST by performing an existing additive processing operation (the build operation in this case) based on the Laser Metal Deposition. Next, one example of the additive processing operation of forming the three-dimensional structural object ST by using the Laser Metal Deposition will be briefly described.

Firstly, with reference to FIG. 4A to FIG. 4E, an operation for forming each structural layer SL will be described. The processing system SYS moves at least one of the processing head 21 and the stage 31 so that the target irradiation area EA is set at a desired area on a build surface MS that corresponds to the surface of the workpiece W or a surface of the formed structural layer SL, under the control of the control apparatus 7. Then, the processing system SYS emits the processing light EL from the irradiation optical system 211 to the target irradiation areas EA. In this case, a condensed plane on which the processing light is condensed may be located on the build surface MS in the Z-axis direction. Alternatively, the condensed plane may be away from the build surface MS in the Z-axis direction. As a result, as illustrated in FIG. 4A, a melt pool (namely, a pool of a metal molten by the processing light EL) MP is formed on the build surface MS that is irradiated with the processing light EL. Moreover, the processing system SYS supplies the build materials M from the material nozzle 212 under the control of the control apparatus 7. As a result, the build materials M are supplied to the melt pool MP. The build materials M supplied to the melt pool MP are molten by the processing light EL with which the melt pool MP is irradiated. Alternatively, the build material M supplied from the material nozzle 212 may be molten by the processing light EL before reaching the melt pool MP and molten build material M may be supplied to the melt pool MP. Then, when the melt pool MP is not irradiated with the processing light EL due to the movement of at least one of the processing head 21 and the stage 31, the build materials M molten in the melt pool MP are cooled and solidified (namely, coagulated). As a result, as illustrated in FIG. 4C, the solidified build materials M are deposited on the build surface MS.

The processing system SYS repeats a series of build process including the formation of the melt pool MP by the irradiation with the processing light EL, the supply of the build materials M to the melt pool MP, the melting of the supplied build materials M and the solidification of the molten build materials M while relatively moving the processing head 21 relative to the build surface MS along at least one of the X-axis direction and the Y-axis direction, as illustrated in FIG. 4D. Here, a moving trajectory of the processing head 21 (alternatively, the target irradiation area EA) may be referred to as a tool path. In this case, the processing system SYS irradiates an area on the build surface MS on which the build object should be formed with the processing light EL and does not irradiate an area on the build surface MS on which the build object should not be formed with the processing light EL. Namely, the processing system SYS moves the target irradiation area EA along a predetermined moving trajectory on the build surface MS and irradiates the build surface MS with the processing light EL at a timing based on an aspect of a distribution of the area on which the build object should be formed. As a result, the melt pool MP also moves on the build surface MS along a moving trajectory based on the moving trajectory of the target irradiation area EA. Specifically, the melt pool MP is formed in series at a part that is irradiated with the processing light EL in the area along the moving trajectory of the target irradiation area EA on the build surface MS. As a result, as illustrated in FIG. 4E, the structural layer SL that is an aggregation of the build object of the build materials M, which are solidified after being molten, is formed on the build surface MS. Namely, the structural layer SL that is an aggregation of the build object formed in a pattern based on the moving trajectory of the melt pool MP on the build surface MS (namely, the structural layer SL having a shape based on the moving trajectory of the melt pool MP in a planar view) is formed. Incidentally, when the target irradiation area EA is set at the area on which the build object should not be formed, the processing system SYS may irradiate the target irradiation areas EA with the processing light EL and stop the supply of the build materials M. Moreover, when the target irradiation areas EA are set at the area on which the build object should not be formed, the processing system SYS may supply the build materials M to the target irradiation areas EA and irradiate the target irradiation areas EA with the processing light EL having an intensity by which the melt pool MP is not formed.

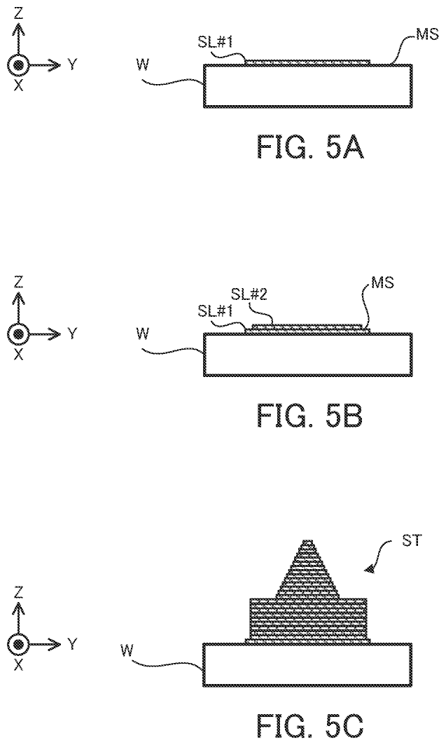

The processing system SYS repeats the operation for forming the structural layer SL based on three-dimensional model data under the control of the control apparatus 7. Specifically, the control apparatus 7 firstly generates slice data by performing a slicing process on the three-dimensional model data by a layer pitch before performing the operation for forming the structural layer SL. The processing system SYS performs an operation for forming a first structural layer SL #1 on the build surface MS that corresponds to the surface of the workpiece W based on the slice data corresponding to the structural layer SL #1. As a result, as illustrated in FIG. 5A, the structural layer SL #1 is formed on the build surface MS. Then, the processing system SYS sets a surface (namely, an upper surface) of the structural layer SL #1 to be a new build surface MS and forms a second structural layer SL #2 on the new build surface MS. In order to form the structural layer SL #2, firstly, the control apparatus 7 controls at least one of the head driving system 22 and the stage driving system 32 so that the processing head 21 moves along the Z-axis direction relative to the stage 31. Specifically, the control apparatus 7 controls at least one of the head driving system 22 and the stage driving system 32 to move the processing head 21 toward the +Z-axis side and/or to move the stage 31 toward the −Z-axis direction so that the target irradiation area EA is set on the surface of the structural layer SL #1 (namely, the new build surface MS). Then, the processing system SYS forms the structural layer SL #2 on the structural layer SL #1 based on the slice data corresponding to the structural layer SL #2, by performing an operation that is the same as the operation for forming the structural layer SL #1 under the control of the control apparatus 7. As a result, as illustrated in FIG. 5B, the structural layer SL #2 is formed. Then, the same process is repeated until all structural layers SL constituting the three-dimensional structural object ST that should be formed on the workpiece W are formed. As a result, the three-dimensional structural object ST is formed by a layered structural object in which the plurality of structural layers SL are layered, as illustrated in FIG. 5C.

### (2) Control System 2

Next, the control system will be described. The control system 8 is an apparatus that is attachable to the processing system SYS. The control system 8 is an apparatus that is detachable from the processing system SYS. However, the control system 8 may be fixed to the processing system SYS. The control system 8 may be integrated with the processing system SYS. The processing system SYS which the control system 8 is attached to, fixed or integrated with may be also referred to as a processing system. Namely, a system that includes the control system 8 and the processing system SYS may be referred to as a processing system.

The control system 8 is configured to control an operation of the processing system SYS in a state where the control system 8 is attached to (or fixed to or integrated with, the same is applied to the below-described description) the processing system SYS. As described above, the operation of the processing system SYS is controlled by the control apparatus 7 of the processing system SYS. In this case, the control system 8 may control the operation of the processing system SYS in cooperation with the control apparatus 7.

In order to control the operation of the processing system SYS, the control system 8 generates a workpiece image WI by capturing an image of at least a part of the workpiece W (especially, at least a part of the melt pool MP). A configuration and operation of the control system 8 will be described below in order.

### (2-1) Configuration of Control System 2

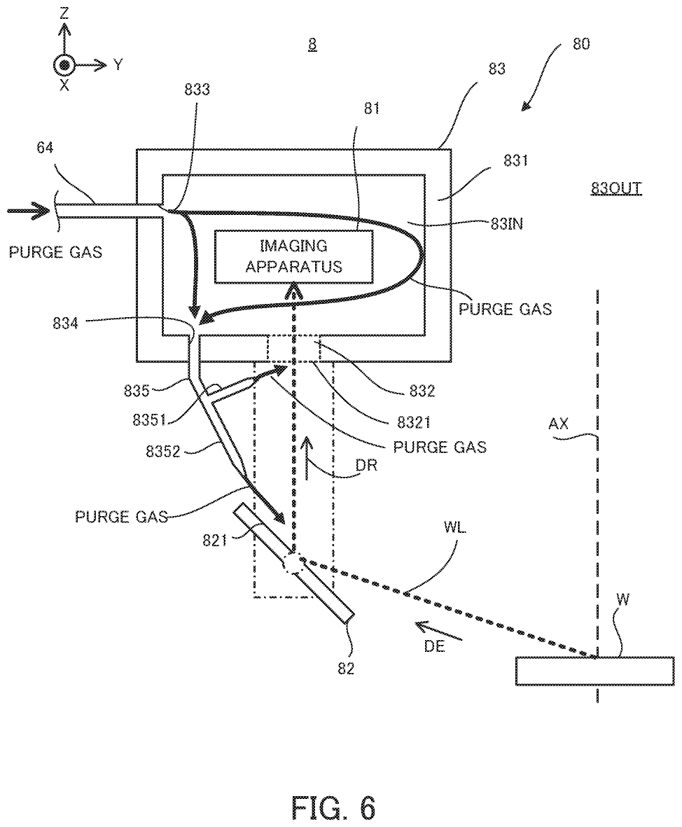

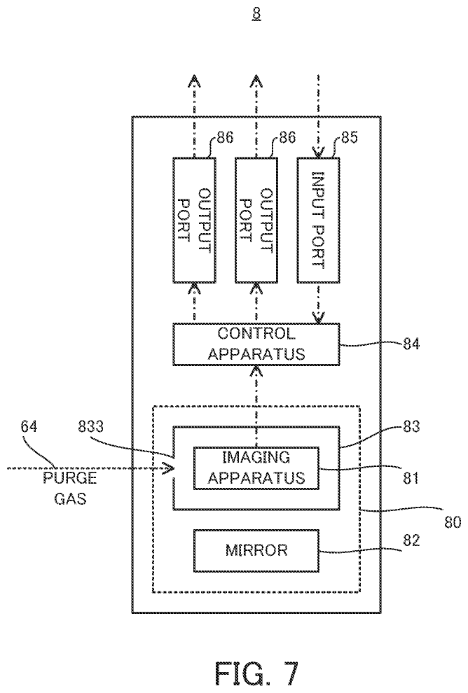

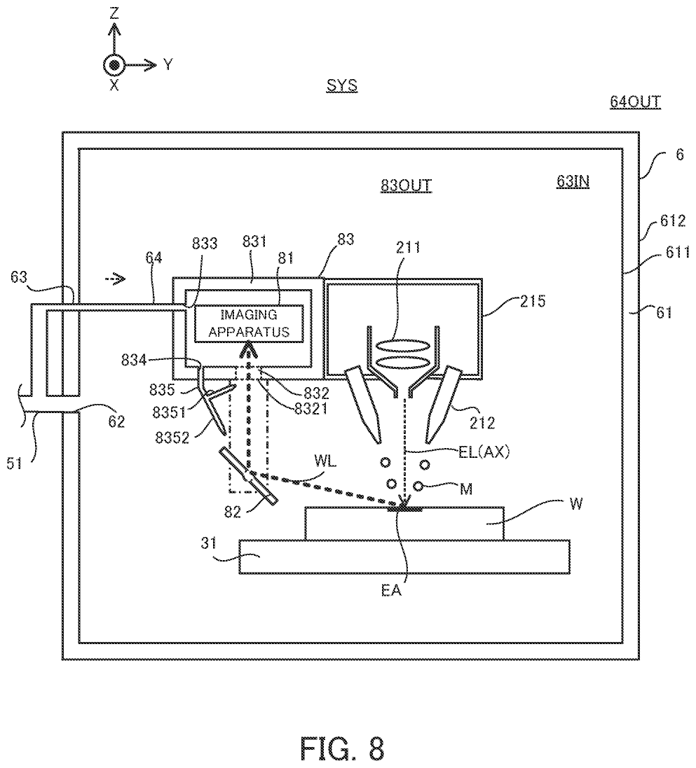

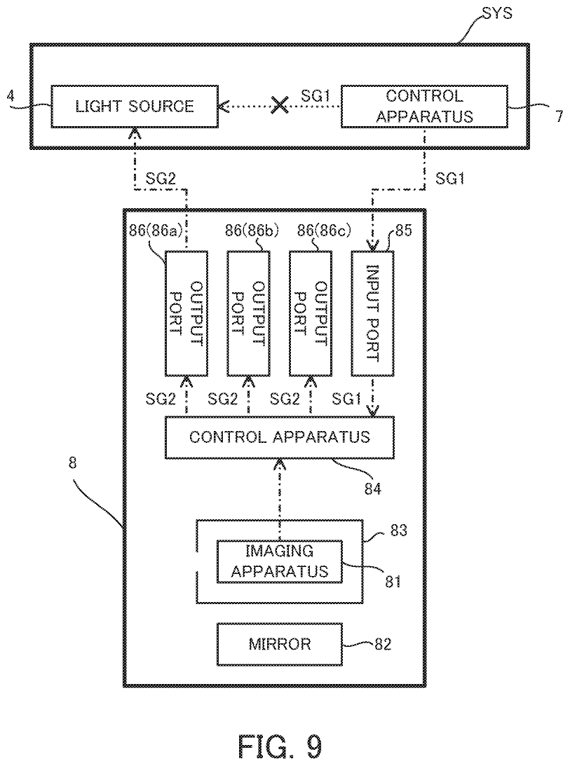

Firstly, with reference to FIG. 6 to FIG. 9, the configuration of the control system 8 in the example embodiment will be described. FIG. 6 is a cross-sectional view that illustrates an example of the configuration of the control system 8 in the present example embodiment. FIG. 7 is a system configuration diagram that illustrates one example of a system configuration of the control system 8 in the present example embodiment. FIG. 8 is a cross-sectional view that illustrates one example of the configuration of the control system 8 attached to the processing system SYS. FIG. 9 is a system configuration diagram that illustrates one example of the system configuration of the control system 8 attached to the processing system SYS.

As mainly illustrated in FIG. 6 and FIG. 8, the control system 8 include an imaging head 80. The imaging head 80 is attachable to the processing head 21. For example, as illustrated in FIG. 8, the imaging head 80 may be attachable to the head housing 215 of the processing head 21. Since the processing head 21 is disposed in the chamber space 63IN, the imaging head 80 may also be disposed in the chamber space 63IN. Namely, the imaging head 80 may be attachable to the processing head 21 in the chamber space 63IN. However, the imaging head 80 may be fixed to the processing head 21. The imaging head 80 may be integrated with the processing head 21.

As described above, the processing head 21 is movable by the head driving system 22. Therefore, when the imaging head 80 is attached to the processing head 21, the imaging head 80 is movable together with the processing head 21.

The imaging head 80 is located at a position that is away from an optical path of the processing light EL with which the workpiece W is irradiated from the processing head 21 (especially, the irradiation optical system 211). As a result, even when the imaging head 80 is attached to the processing head 21, the processing light EL is not shielded by the imaging head 80. Namely, even when the imaging head 80 is attached to the processing head 21, the workpiece W is properly irradiated with the processing light EL. Moreover, the imaging head 80 is located at a position that is away from a supply path of the build materials M supplied from the processing head 21 (especially, the material nozzle 212) to the workpiece W. As a result, even when the imaging head 80 is attached to the processing head 21, the build materials M is not blocked by the imaging head 80. Namely, even when the imaging head 80 is attached to the processing head 21, the build materials M is appropriately supplied to the workpiece W. In an example illustrated in FIG. 8, the imaging head 80 is attached to the processing head 21 at the side of the processing head 21. However, the imaging head 80 may be attached to the processing head 21 at any position.

Note that a state where “the imaging head 80 is attached to the processing head 21” in the present example embodiment may include a state where “a position of the imaging head 80 relative to the processing head 21 is adjusted so that the imaging head 80 physically contacts with the processing head 21”. The state where “the imaging head 80 is attached to the processing head 21” may include a state where “a position of the imaging head 80 relative to the processing head 21 is adjusted so that the imaging head 80 does not physically contact with the processing head 21”. The same is applied to a state where “the control system 8 is attached to the processing system SYS”.

The imaging head 80 is used to capture the image of at least a part of the workpiece W (especially, at least a part of the melt pool MP formed on the workpiece W). Here, when the imaging head 80 is attached to the processing head 21 as described above, the imaging head 80 is attached to the processing head 21 so that at least a part of the workpiece W (especially, at least a part of the melt pool MP formed on the workpiece W) appears in an imaging range of the imaging head 80 in the state where the imaging head 80 is attached to the processing head 21. In this case, since the imaging head 80 moves together with the processing head 21, even when the head driving system 22 moves the processing head 21, at least a part of the workpiece W (especially, at least a part of the melt pool MP formed on the workpiece W) appears in the imaging range of the imaging head 80. Namely, the imaging range of the imaging head 80 is capable of substantially following at least a part of the workpiece W (especially, at least a part of the melt pool MP formed on the workpiece W) that should be captured by the imaging head 80.

The imaging head 80 captures the image of at least a part of the melt pool MP in the state where the imaging head 80 is attached to the processing head 21. In order to capture the image of at least a part of the melt pool MP, the imaging head 80 includes an imaging apparatus 81, a mirror 82, and a housing 83.

The imaging apparatus 81 is a camera that is configured to capture the image of at least a part of the workpiece W (especially, at least a part of the melt pool MP). Specifically, the imaging apparatus 81 includes an imaging element configured to optically receive light from at least a part of the workpiece W (especially, at least a part of the melt pool MP). In the below-described description, the light from at least a part of the workpiece W is referred to as “workpiece light WL”. The imaging apparatus 81 captures the image of at least a part of the workpiece W (especially, at least a part of the melt pool MP) by optically receiving (namely, detecting) the workpiece light WL by the imaging element. Thus, the imaging apparatus 81 may be referred to as a detection apparatus or a light reception apparatus. As a result, the imaging apparatus 81 generates the workpiece image WI in which at least a part of the workpiece W (especially, at least a part of the melt pool MP) appears. Note that the workpiece image WI may be regarded to be information indicating a detected result of the workpiece light WL.

Incidentally, as described above, the workpiece W is irradiated with the processing light EL. Therefore, there is a possibility that the processing light EL through the workpiece W (for example, the processing light EL reflected by the workpiece W) enters the imaging element of the imaging apparatus 81. Here, an intensity of the processing light EL is set to be an intensity that allows the workpiece W to be molten. Therefore, when the processing light EL through the workpiece W enters the imaging element of the imaging apparatus 81, the imaging element may fail due to the processing light EL. Thus, the imaging head 80 may be configured to prevent the processing light EL from the workpiece W from entering the imaging apparatus 81. For example, the imaging head 80 may include an optical element that prevents the processing light EL from the workpiece W from entering the imaging apparatus 81. A filter whose transmittance relative to the processing light EL is relatively low and whose transmittance relative to the workpiece light WL is relatively high is one example of the optical element. A filter whose absorptivity relative to the processing light EL is relatively high and whose absorptivity relative to the workpiece light WL is relatively low is one example of such an optical element.

The mirror 82 is an optical member for guiding the workpiece light WL from the workpiece W (namely, the workpiece light WL emitted from the workpiece W) to the imaging apparatus 81. Specifically, the mirror 82 is an optical member for reflecting the workpiece light WL from the workpiece W toward the imaging apparatus 81. Namely, the mirror 82 is an optical member for guiding the workpiece light WL that propagates from the workpiece W along a certain propagating direction DE (see FIG. 6) (Namely, that is emitted from the workpiece W toward a certain emission direction) to the imaging apparatus 81 by deflecting it toward a reflection direction DR (see FIG. 6) that intersects with the propagating direction DE. As a result, the imaging apparatus 81 generates the workpiece image WI by optically receiving the workpiece light WL reflected (namely, deflected) by the mirror 82.

In the present example embodiment, an angle between an axis extending along the reflection direction DR and the optical axis AX of the irradiation optical system 211 may be smaller than an angle between an axis extending along the propagating direction DE and the optical axis AX. For example, in the example illustrated in FIG. 6 and FIG. 8, the mirror 82 reflects the workpiece light WL, which is emitted from the workpiece W toward a lateral side of the workpiece W, toward a space above the mirror 82 (for example, direct upward direction or diagonal upward direction). Namely, as illustrated in FIG. 6 and FIG. 8, the propagating direction DE may be a direction directed from the workpiece W toward a first space on the lateral side of the workpiece W. The first space may include, for example, a space in which the mirror 82 is disposed. Moreover, as illustrated in FIG. 6 and FIG. 8, the reflection direction DR may be a direction directed from the first space toward a second space above the first space. The second space may include, for example, a space in which the imaging head 80 (especially, the imaging apparatus 81) is disposed. The second space may include, for example, a space at a lateral side of the processing head 21 (especially, the irradiation optical system 211). In this case, typically, the angle between the axis extending along the reflection direction DR and the optical axis AX is smaller than the angle between the axis extending along the propagating direction DE and the optical axis AX. When such a first condition that the angle between the axis extending along the reflection direction DR and the optical axis AX of the irradiation optical system 211 is smaller than the angle between the axis extending along the propagating direction DE and the optical axis AX is satisfied, the imaging head 80 can be disposed at a position closer to the processing head 21, compared to a case where the first condition is not satisfied. As a result, the size of the processing head 21 to which the imaging head 80 is attached is reducible.

When the mirror 82 reflects the workpiece light WL toward the space above the mirror 82, the mirror 82 may reflect the workpiece light WL so that the workpiece light WL propagates from the mirror 82 along a direction parallel to the optical axis AX of the irradiation optical system 211. Namely, the reflection direction DR in which the mirror 82 reflects the workpiece light WL may be parallel to the optical axis AX. On the other hand, the propagating direction DE in which the workpiece light WL propagates from the workpiece W toward the mirror 82 may be a direction intersecting with the optical axis AX. When such a second condition that the reflection direction DR is along the optical axis AX and the propagating direction DE intersects with the optical axis AX is satisfied, the imaging head 80 can be disposed at a position closer to the processing head 21, compared to a case where the second condition is not satisfied. As a result, the size of the processing head 21 to which the imaging head 80 is attached is reducible.

The housing 83 is a housing apparatus that is configured to contain the imaging apparatus 81. Specifically, a containing space 83IN for containing the imaging apparatus 81 is formed in the housing 83. The housing 83 contains the imaging apparatus 81 in the containing space 83IN, which is an internal space of the housing 83. The housing 83 includes a wall member 831 that defines the containing space 83IN. The wall member 831 is a member that separates the containing space 83IN from an external space 83OUT located outside the housing 83. The wall member 831 faces the containing space 83IN through its inner wall surface and faces the external space 83OUT through its outer wall surface. In this case, a space surrounded by the wall member 831 (more specifically, a space surrounded by the inner wall surface of the wall member 831) is the containing space 83IN.

When the imaging head 80 is attached to the processing head 21, the external space 83OUT of the housing 83 is included in at least a part of the chamber space 63IN in which the workpiece W is disposed. In this case, the wall member 831 may serve as a member that separates the containing space 83IN from the chamber space 63IN. As a result, the wall member 831 (namely, the housing 83) may serve as an apparatus that prevents the unnecessary substance existing in the chamber space 63IN from adhering to the imaging apparatus 81. Note that the chamber space 63IN may be referred to as a processing space, because the workpiece W is processed in the chamber space 63IN.

As described above, the imaging apparatus 81 contained in the containing space 83IN optically receives the workpiece light WL from the workpiece W. Thus, a part of the wall member 831 may include a passing member 832 through which the workpiece light WL is allowed to pass from the external space 83OUT in which the workpiece W is disposed to the containing space 83IN in which the imaging apparatus 81 is contained. Namely, a part of the wall member 831 may be the passing member 832. Specifically, a part of the wall member 831 that overlaps an optical path of the workpiece light WL may be the passing member 832. As a result, the imaging apparatus 81 is capable of optically receiving the workpiece light WL even when the imaging apparatus 81 is contained in the housing 83.

The imaging head 80 may further include a cooling mechanism for cooling the imaging apparatus 81. For example, the imaging head 80 may include the cooling mechanism (an air cooling mechanism) for cooling the imaging apparatus 81 by using gas. For example, the imaging head 80 may include the cooling mechanism (a water cooling mechanism) for cooling the imaging apparatus 81 by using liquid. However, the imaging head 80 may not include the cooling mechanism for cooling the imaging apparatus 81.

FIG. 6 and FIG. 8 illustrates an example in which the imaging head 80 includes the air cooling mechanism. Specifically, as illustrated in FIG. 6 and FIG. 8, a supply port 833 that is a through hole penetrating the wall member 831 may be formed in the wall member 831 of the housing 83. A supply pipe 64 to which the gas for cooling the imaging apparatus 81 is supplied may be connected to the supply port 833. The purge gas supplied by the gas supply apparatus 5 may be used as the gas for cooling the imaging apparatus 81. In this case, the supply pipe 64 may be connected to the supply pipe 51, which is connected to the gas supply apparatus 5, through a supply port 63 formed in the wall member 61 of the housing 6. In this case, the gas supply apparatus 5 supplies the purge gas to the containing space 83IN in which the imaging apparatus 81 is contained through the supply pipe 51, the supply port 63, the supply pipe 64, and the supply port 833. Namely, the purge gas that is the same type as the purge gas supplied by the gas supply apparatus 5 to the chamber space 63IN (namely, an atmosphere of the processing apparatus 2) may be supplied to the containing space 83IN. The purge gas that is the same type as the purge gas supplied by the gas supply apparatus 5 to the internal space 2141 of the barrel 214 of the processing head 21 (furthermore, the purge gas discharged from the barrel 214 to form the flow around the material nozzle 212) may be supplied to the containing space 83IN. The purge gas that is the same type as the purge gas for pressure-feeding the build materials M may be supplied to the containing space 83IN. As a result, the imaging apparatus 81 is cooled by the purge gas. Note that the purge gas supplied to the containing space 83IN may be used to cool an apparatus or a member different from the imaging apparatus 81. For example, the purge gas supplied to the containing space 83IN may be used to cool at least one of the mirror 82 and the housing 83.

However, gas supplied by a gas supply apparatus that is different from the gas supply apparatus 5 may be used to cool the imaging apparatus 81. Namely, gas that is different from the purge gas may be used as the gas for cooling the imaging apparatus 81. In this case, the supply pipe 64 may be connected to the gas supply apparatus that is different from the gas supply apparatus 5 through the supply port 63.

A discharge port 834 for discharging the purge gas (alternatively, gas different from the purge gas, the same is applied to the below-described description), which has been supplied to the containing space 83IN, from the containing space 83IN may be formed in the housing 83. The discharge port 834 is a through hole that penetrates the wall member 831. The purge gas discharged from the discharge port 834 may be discharged to the external space 83OUT of the housing 83 (namely, the chamber space 63IN).

The imaging head 80 may use the purge gas discharged from the discharge port 834 to prevent the unnecessary substance existing in the chamber space 63IN (for example, at least one of the build material M and fume, as described above) from adhering to at least a part of the imaging head 80. The imaging head 80 may use the purge gas discharged from the discharge port 834 to remove the unnecessary substance adhering to at least a part of the imaging head 80. However, the imaging head 80 may not use the purge gas discharged from the discharge port 834 to prevent the unnecessary substance from adhering to a protection target part. The imaging head 80 may not remove the unnecessary substance adhering to the protection target part.

In order to prevent the unnecessary substance from adhering to at least a part of the imaging head 80 and/or to remove the unnecessary substance adhering to at least a part of the imaging head 80, a supply pipe 835 may be connected to the discharge port 834. The supply pipe 835 is a supply part for supplying the purge gas discharged from the discharge port 834 to at least a part of the imaging head 80. As a result, the purge gas supplied to at least a part of the imaging head 80 through the supply pipe 835 prevents the unnecessary substance from adhering to at least a part of the imaging head 80. In this case, it can be said that the purge gas is supplied through the supply pipe 835 to prevent the unnecessary substance from adhering to at least a part of the imaging head 80. Alternatively, the purge gas supplied to at least a part of the imaging head 80 through the supply pipe 835 removes the unnecessary substance adhering to at least a part of the imaging head 80. In this case, the purge gas may be regarded to be supplied through the supply pipe 835 to remove the unnecessary substance adhering to at least a part of the imaging head 80.

The imaging head 80 may use the purge gas discharged from the discharge port 834 to prevent the unnecessary substance from adhering to the protection target part of the imaging head 80 to which it is undesirable for the unnecessary substance to adhere and/or to remove the unnecessary substance from the protection target part. In this case, the supply pipe 835 may supply the purge gas to the protection target part of the imaging head 80. The supply pipe 835 may extend from the discharge port 834 toward the protection target part of the imaging head 80.

A surface 8321 (specifically, a surface facing the chamber space 63IN) of the passing member 832 of the housing 83 through which the workpiece light WL passes is one example of the protection target part. This is because there is a possibility that at least a part of the workpiece light WL is shielded by the unnecessary substance when the unnecessary substance adheres to the surface 8321 of the passing member 832, resulting in the imaging apparatus 81 being unable to optically receive the workpiece light WL properly. In this case, the supply pipe 835 may include a supply pipe 8351 that may serve as a supply part configured to supply the purge gas to at least a part of the surface 8321 of the passing member 832. The supply pipe 8351 may include a supply pipe extending from the discharge port 834 toward the surface 8321 of the passing member 832. The purge gas supplied through the supply pipe 8351 may be regarded to be supplied to prevent the unnecessary substance from adhering to the surface 8321 of the passing member 832 and/or to remove the unnecessary substance from the surface 8321 of the passing member 832.

A reflective surface 821 of the mirror 82 by which the workpiece light WL is reflected is one example of the protection target part. This is because there is a possibility that the reflection of at least a part of the workpiece light WL is prevented by the unnecessary substance when the unnecessary substance adheres to the reflective surface 821 of the mirror 82, resulting in the imaging apparatus 81 being unable to optically receive the workpiece light WL properly. In this case, the supply pipe 835 may include a supply pipe 8352 that may serve as a supply part configured to supply the purge gas to at least a part of the reflective surface 821 of the mirror 82. The supply pipe 8352 may typically include a supply pipe extending from the discharge port 834 toward the reflective surface 8322 of the mirror 82. The purge gas supplied through the supply pipe 8352 may be regarded to be supplied to prevent the unnecessary substance from adhering to the reflective surface 8322 of the mirror 82 and/or to remove the unnecessary substance from the reflective surface 8322 of the mirror 82. Moreover, the purge gas supplied through the supply pipe 8352 is supplied from the gas supply apparatus 5, as with the purge gas supplied through the supply pipe 8351. Therefore, either one of the supply pipes 8351 and 8352 may be regarded to supply the purge gas the type of which is the same as that of the purge gas supplied by the other one of the supply pipes 8351 and 8352.

Each of the surface 8321 of the passing member 832 and the reflective surface 821 of the mirror 82 is one example of an optical surface of the imaging head 80 (especially, an optical surface through which the workpiece light WL passes). Namely, the optical surface of the imaging head 80 (especially, the optical surface through which the workpiece light WL passes) is one example of the protection target part. Thus, the supply pipe 835 may supply the purge gas to any optical surface of the imaging head 80 (especially, an optical surface through which the workpiece light WL passes) that is different from the surface 8321 of the passing member 832 and the reflective surface 821 of the mirror 82.

When the purge gas is supplied to the optical surface of the imaging head 80, a supply direction of the purge gas supplied from the supply pipe 835 (namely, a direction along which the purge gas flows) may include a directional component along the optical surface. For example, the supply direction of the purge gas supplied from the supply pipe 8351 to the surface 8321 of the passing member 832 may include a directional component along the surface 8321 of the passing member 832. For example, the supply direction of the purge gas supplied from the supply pipe 8351 to the reflective surface 821 of the mirror 82 may include a directional component along the reflective surface 821 of the mirror 82. In this case, the unnecessary substance is prevented from adhering to the optical surface of the imaging head 80 more efficiently and/or the unnecessary substance adhering to the optical surface of the imaging head 80 is removed more efficiently.

The supply direction of the purge gas supplied from the supply pipe 835 may include a directional component along a gravity direction. In this case, the unnecessary substance is prevented from adhering to the optical surface of the imaging head 80 more efficiently and/or the unnecessary substance adhering to the optical surface of the imaging head 80 is removed more efficiently. This is because the unnecessary substance blown away by the purge gas is more likely to fall by gravity.

Note that the imaging head 80 may use gas different from the purge gas discharged from the discharge port 834 to prevent the unnecessary substance from adhering to the protection target part and/or to remove the unnecessary substance adhering to the protection target part. For example, the imaging head 80 may use the purge gas supplied from the gas supply apparatus 5 to the chamber space 63IN to prevent the unnecessary substance from adhering to the protection target part and/or to remove the unnecessary substance adhering to the protection target part. For example, the imaging head 80 may use gas supplied from a gas supply apparatus different from the gas supply apparatus 5 to prevent the unnecessary substance from adhering to the protection target part and/or to remove the unnecessary substance adhering to the protection target part.

Furthermore, as mainly illustrated in FIG. 7 and FIG. 9, the control system 8 may include a control apparatus 84. The control apparatus 84 is configured to control the operation of the processing system SYS based on the workpiece image WI generated by the imaging apparatus 81. For example, the control apparatus 84 may generate characteristic information related to a characteristic of the melt pool MP based on the workpiece image WI and control the operation of the processing system SYS based on the characteristic information. In this case, the control apparatus 84 may serve as a characteristic information generation apparatus configured to generate the characteristic information. In the present example embodiment, an example in which the control apparatus 84 calculates a size of the melt pool MP based on the workpiece image WI (namely, generates the characteristic information related to the size of the melt pool MP), and control, based on the calculated size of the melt pool MP, the operation of the processing system SYS so as to satisfy such a condition that the size of the melt pool MP is maintained constant (namely, the size of the melt pool MP matches the target size) will be described. However, the control apparatus 84 may control, based on the workpiece image WI, any apparatus (for example, at least one of the material supply source 1, the processing apparatus 2, the stage apparatus, and the gas supply apparatus 5) of the processing system SYS so as to satisfy any condition.

Specifically, the control apparatus 84 may calculate the size of the melt pool MP in the workpiece image WI based on the workpiece image WI. Then, the control apparatus 84 may set a target intensity of the processing light EL generated by the light source 4 based on the calculated size of the melt pool MP.

For example, when the calculated size of the melt pool MP is smaller than the target size, the control apparatus 84 may set a new target intensity that is higher than a reference value of the target intensity (alternatively, a current target intensity, the same is applied to the below-described description). In this case, an amount of build materials M to be melted increases because the intensity of the processing light EL with which the workpiece W is irradiated is higher, compared to a case where the new target intensity has not been set. As a result, the size of the melt pool MP, which was smaller than the target size, is increased so that the size of the melt pool MP matches the target size, compared to the case where the new target intensity has not been set.

For example, when the calculated size of the melt pool MP is larger than the target size, the control apparatus 84 may set a new target intensity that is lower than the reference value of the target intensity. In this case, an amount of build materials M to be melted increases because the intensity of the processing light EL with which the workpiece W is irradiated is lower, compared to a case where the new target intensity has not been set. As a result, the size of the melt pool MP, which was larger than the target size, is decreased so that the size of the melt pool MP matches the target size, compared to the case where the new target intensity has not been set.

For example, when the calculated size of the melt pool MP matches the target size, the target intensity may be maintained to be the reference value. Namely, the control apparatus 84 may continue to set the reference value of the target intensity to the target intensity as it is. In this case, the amount of build materials M to be melted does not change because the intensity of the processing light EL with which the workpiece W is irradiated is maintained. As a result, the size of the melt pool MP, which matched the target size, is maintained.

A larger one of a size of the melt pool MP along a predetermined direction (for example, one of the x-axis direction, the y-axis direction, and the z-axis direction) and a size of the melt pool MP in a direction that intersects with (typically orthogonal to) the predetermined direction may be used as the size of the melt pool MP. A smaller one of the size of the melt pool MP along the predetermined direction and the size of the melt pool MP in the direction that intersects with (typically orthogonal to) the predetermined direction may be used as the size of the melt pool MP. An average value of the size of the melt pool MP along the predetermined direction and the size of the melt pool MP in the direction that intersects with (typically orthogonal to) the predetermined direction may be used as the size of the melt pool MP. An area size of the melt pool MP may be used as the size of the melt pool MP. The area size of the melt pool MP may be used as the size of the melt pool MP.

The reference value of the target intensity may be a target intensity set when the control apparatus 7 of the processing system SYS controls the light source 4. Namely, the target intensity set by the control apparatus 7 may be used as the reference value of the target intensity. For example, when the control apparatus 7 controls the light source 4 so that the intensity of the processing light EL generated by the light source 4 is to be the desired intensity, the desired intensity may be used as the reference value of the target intensity.

The reference value of the target intensity (for example, the target intensity set when the control apparatus 7 controls the light source 4) may be set in advance based on a result of a physical simulation such as a thermal analysis. For example, the reference value of the target intensity may be set in advance based on a result of a physical simulation analyzing a thermal distribution of the workpiece W in a series of processing operation in which the workpiece W is irradiated with the processing light EL. Alternatively, the control apparatus 84 may set the reference value of the target intensity (for example, the target intensity set when the control apparatus 7 controls the light source 4 to process an unprocessed part of the workpiece W that has not yet been processed) in a period during which the workpiece W is actually being processed. For example, the control apparatus 84 may set the reference value of the target intensity based on information related to a state of the processed part of the workpiece W that has already been processed in the period during which the workpiece W is actually being processed.

The control apparatus 84 may acquire information related to the reference value of the target intensity from the control apparatus 7 of the processing system SYS. Specifically, as illustrated in FIG. 9, the control apparatus 7 generates a control signal SG1 for controlling the light source 4 so that the intensity of the processing light EL generated by the light source 4 is to be the target intensity set by the control apparatus 7 (namely, the reference value of the target intensity), and controls the light source 4 by outputting the generated control signal SG1 to the light source 4. In this case, the control apparatus 84 may acquire the control signal SG1 as the information related to the reference value of the target intensity, as illustrated in FIG. 9. In this case, the control apparatus 84 may be regarded to set the target intensity of the processing light EL based on the workpiece image WI and the control signal SG1.

When the control signal SG1 (namely, the information related to the reference value of the target intensity) is acquired from the control apparatus 84, the control system 8 may include an input port 85. The input port 85 is configured to be connected to the processing system SYS (especially, the control apparatus 7). The control signal SG1 is allowed to be inputted to the input port 85 from the control apparatus 7. The control apparatus 84 may acquire the control signal SG1 from the control apparatus 7 through the input port 85. Note that any signal (information) acquired by the control system 8 from the processing system SYS may be inputted to the input port 85. The control system 8 may acquire any signal (information) from the processing system SYS through the input port 85.

After the target intensity is set, the control apparatus 84 generates a control signal SG2 for controlling the light source 4 so that the intensity of the processing light EL generated by the light source 4 is to be the target intensity set by the control apparatus 84. Namely, the control apparatus 84 generates the control signal SG2 for controlling the intensity (namely, the characteristic) of the processing light EL generated by the light source 4 so that the intensity of the processing light EL generated by the light source 4 is to be the target intensity set by the control apparatus 84.

As described above, the control system 8 is attachable to and detachable from the processing system SYS. Thus, the control system 8 is attachable to a plurality of different processing systems SYS. In this case, a signal form (in other words, the signal format) of the control signal for controlling the light source 4 of a first processing system SYS is not necessarily the same as a signal form of the control signal for controlling the light source 4 of a second processing system SYS that is different from the first processing system SYS. Thus, the control apparatus 84 may be configured to generate the control signals SG2 having a plurality of different signal forms. Namely, the control apparatus 84 may be configured to generate the plurality of different control signals SG2 that comply with the plurality of different signal forms, respectively. For example, the control apparatus 84 may be configured to generate a control signal SG2 corresponding to a digital signal, a control signal SG2 corresponding to an analogue signal, and a control signal SG2 corresponding to a PWM (Pulse Width Modulation) signal.

When the control apparatus 84 generates the control signal SG2, the control apparatus 84 may output the control signal SG2 to the light source 4, as illustrated in FIG. 9. In this case, the light source 4 is driven based on the control signal SG2 generated by the control apparatus 84, instead of the control signal SG1 generated by the control apparatus 7, as illustrated in FIG. 9.

In order to output the control signal SG2 to the light source 4, the control system 8 may include an output port 86. The output port 86 is configured to be connected to the processing system SYS (especially, the light source 4). The output port 86 is configured to output the control signal SG2 generated by the control apparatus 84 to the light source 4. The control apparatus 84 may output the control signal SG2 to the light source through the output port 86. The control signal SG2 may be inputted to the light source 4 from the control apparatus 84 through the output port 86. Note that the output port 86 may output any signal (information) outputted from the control system 8 to the processing system SYS. The control system 8 may output any signal (information) to the processing system SYS through the output port 86.

When the control apparatus 84 is configured to generate the plurality of control signals SG2 that comply with the plurality of different signal forms, respectively, as described above, the control system 8 may include a plurality of output ports 86 that are configured to output the plurality of control signals SG2, respectively. For example, as illustrated in FIG. 9, the control system 8 may include the output port 86 (an output port 86a in FIG. 9) configured to output the control signal SG2 corresponding to the digital signal, the output port 86 (an output port 86b in FIG. 9) configured to output the control signal SG2 corresponding to the analogue signal, and the output port 86 (an output port 86c in FIG. 9) configured to output the control signal SG2 corresponding to the PWM signal. In this case, one output port 86 of the plurality of output ports 86, which is configured to output the control signal SG2 having the signal form suitable for the processing system SYS to which the control system 8 is attached, may be connected to the processing system SYS. Alternatively, the control apparatus 84 may select one output port 86 out of the plurality of output ports 86 that should output the control signal SG2 to the processing system SYS based on the signal form of the control signal SG2 generated by the control apparatus 84, and output the control signal SG2 to the processing system SYS by using the selected output port 86. Alternatively, a user of the processing system SYS may select (in other words, set) one output port 86 out of the plurality of output ports 86 that should output the control signal SG2 to the processing system SYS, and the control apparatus 84 may output the control signal SG2 to the processing system SYS by using the output port 86 selected by the user.

Alternatively, even when the control apparatus 84 is configured to generate the plurality of control signals SG2 that comply with the plurality of different signal forms, respectively, the control system 8 may include a single output port 86 that is configured to serve as the plurality of output ports 86 (for example, the output ports 86a to 86c illustrated in FIG. 9) that are configured to output the plurality of control signals SG2, respectively. In this case, the control apparatus 84 may output the control signal SG2, which has the signal form that is usable to control the light source 4 to which the output port 86 is connected, out of the plurality of control signals SG2 to the light source 4. Namely, the control apparatus 84 may select the control signal SG2, which has the signal format suitable for the processing system SYS to which the control system 8 is attached (namely, the signal format that is usable by the processing system SYS), from the plurality of control signals SG2, and output the selected control signal SG2 to the light source 4. In this case, the control apparatus 84 may actually generate the plurality of control signals SG2 and output, to the light source 4, one control signal SG2 having the signal format suitable for the processing system SYS out of the plurality of control signals SG2 actually generated. Alternatively, the control apparatus 84 may generate one control signal SG2 having the signal format suitable for the processing system SYS and output the generated one control signal SG2 to the light source 4. In other words, the control apparatus 84 may not generate other control signal SG2 having the signal format that is not suitable for the processing system SYS.

The control system 8 and the processing system SYS may be connected by using a single signal cable. For example, an input/output connector of the control system 8 and an input/output connector of the processing system SYS may be connected by using the single signal cable. In this case, the control signal SG1 may be inputted to the input port 85 through at least one signal pin of the input/output connector. The control signal SG2 may be outputted from the output port 86 through at least one other signal pin of the input/output connector. A D-sub connector is one example of the input/output connector. However, the input/output connector the type of which is different from that of the D-sub connector may be used.

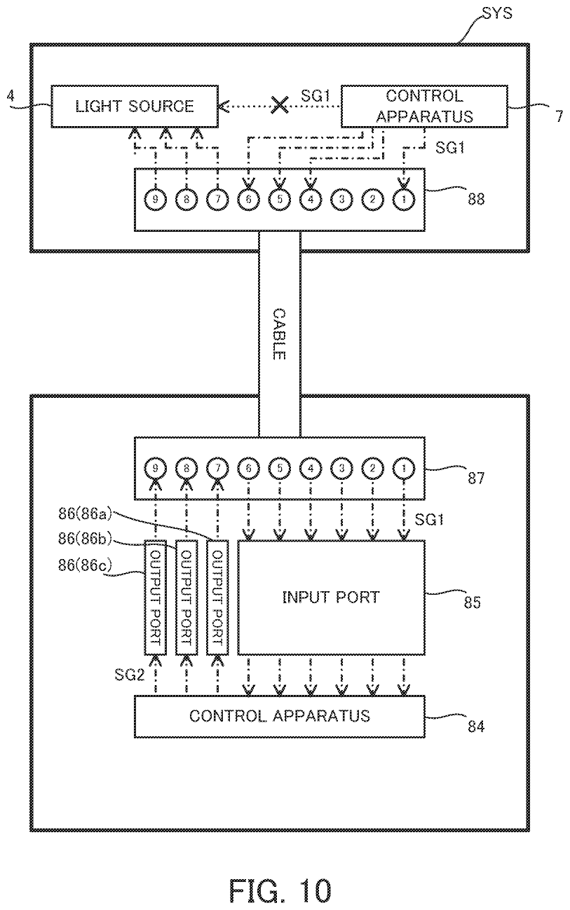

As one example, FIG. 10 illustrates an example in which the control system 8 includes the input/output connector 87 that is the D-sub connector having nine signal pins, and the processing system SYS includes the input/output connector 88 that is the D-sub connector having nine signal pins. In the example illustrated in FIG. 10, a first signal pin to a sixth signal pin of the input/output connector 87 are connected to the input port 85 and a seventh signal pin to a ninth signal pin of the input/output connector 87 are connected to the output port 86 (the output ports 86a to 86c in the example illustrated in FIG. 10). In this case, for example, the first signal pins of the input/output connectors 87 and 88 may be used to input the control signal SG1 having the first signal form (for example, the control signal SG1 corresponding to the digital signal) from the control apparatus 7 to the control apparatus 84. For example, the second signal pins of the input/output connectors 87 and 88 may be used to input the control signal SG1 having the second signal form (for example, the control signal SG1 corresponding to the analogue signal) from the control apparatus 7 to the control apparatus 84. For example, the third signal pins of the input/output connectors 87 and 88 may be used to input the control signal SG1 having the third signal form (for example, the control signal SG1 corresponding to the PWM signal) from the control apparatus 7 to the control apparatus 84. For example, the fourth signal pins of the input/output connectors 87 and 88 may be used to input light ON/Off information, which indicating whether or not the light source 4 is generating processing light EL, from the control apparatus 7 to the control apparatus 84. For example, the fifth signal pins of the input/output connectors 87 and 88 may be used to input moving direction information related to a moving direction of the processing light EL on the workpiece W (namely, a moving direction of the target irradiation area EA) from the control apparatus 7 to the control apparatus 84. For example, the sixth signal pins of the input/output connectors 87 and 88 may be used to input speed information related to a moving speed of the processing light EL on the workpiece W (namely, a moving speed of the target irradiation area EA) from the control apparatus 7 to the control apparatus 84. For example, the seventh signal pins of the input/output connectors 87 and 88 may be used to output the control signal SG2 having the first signal form (for example, the control signal SG2 corresponding to the analogue signal) from the control apparatus 84 to the control apparatus 7. For example, the eighth signal pins of the input/output connectors 87 and 88 may be used to output the control signal SG2 having the second signal form (for example, the control signal SG2 corresponding to the digital signal) from the control apparatus 84 to the control apparatus 7. For example, the ninth signal pins of the input/output connectors 87 and 88 may be used to output the control signal SG2 having the third signal form (for example, the control signal SG2 corresponding to the PWM signal) from the control apparatus 84 to the control apparatus 7.

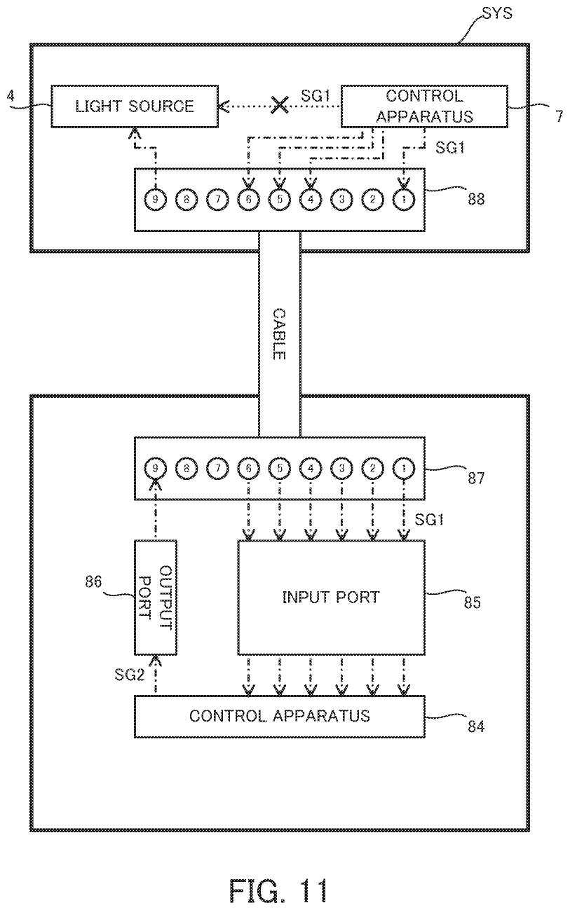

Alternatively, as another example, FIG. 11 illustrates an example in which the control system 8 includes the single output port 86 that is configured to serve as the plurality of output ports 86 (for example, the output ports 86a to 86c illustrated in FIG. 10) that are configured to output the plurality of control signals SG2 complying with the plurality of different signal forms, respectively, and the ninth signal pin of the input/output connector 87 is connected to the output port 86. In this case, the ninth signal pins of the input/output connectors 87 and 88 may be used to output each of the plurality of control signals SG2 complying with the plurality of different signal forms from control apparatus 84 to control system 7.

### (2-2) Operation of Control System 2

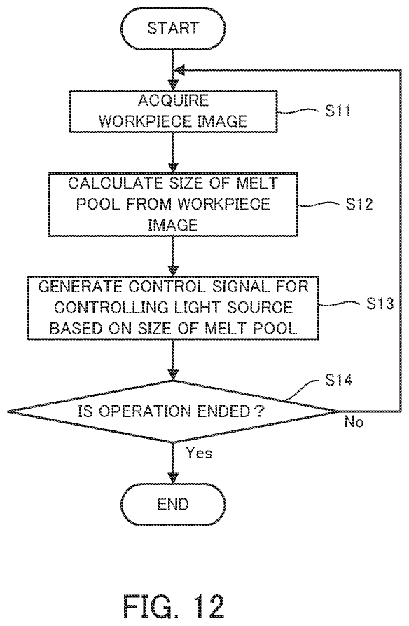

Next, with reference to FIG. 12, the operation of the control system 8 will be described. FIG. 12 illustrates a flowchart that illustrates a flow of the operation of the control system 8. Note that the operation illustrated in FIG. 12 may be performed in at least a part of a period during which the control system 8 is attached to the processing system SYS.

As illustrated in FIG. 12, the control apparatus 84 acquires the workpiece image WI from the imaging apparatus 81 (a step S11). Then, the control apparatus 84 calculates the size of the melt pool MP appearing in the workpiece image WI based on the workpiece image WI acquired at the step S11 (a step S12).

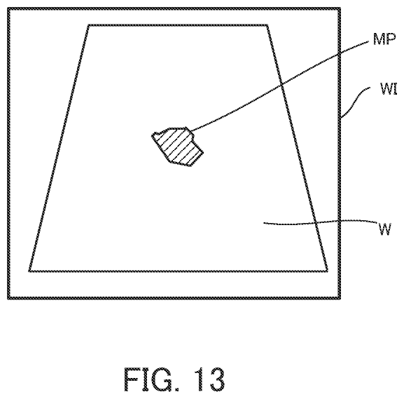

Specifically, as described above, the imaging apparatus 81 captures the image of at least a part of the workpiece W (especially, at least a part of the melt pool MP). Thus, as illustrated in FIG. 13 that illustrates one example of the workpiece image WI, at least a part of the workpiece W (especially, at least a part of the melt pool MP) appears in the workpiece image WI. Here, an intensity of the workpiece light WL from a part of the workpiece W at which the melt pool MP is formed is typically higher than an intensity of the workpiece light WL from a part of the workpiece W at which the melt pool MP is not formed. Thus, a difference in the intensity of the workpiece light WL appears as a difference in brightness (typically a difference in gradation) on the workpiece image WI. Thus, the control apparatus 84 is capable of relatively easily identifying a part of the workpiece image WI at which the melt pool MP appears based on the brightness (the gradation) of the workpiece image WI.

For example, the control apparatus 84 may identify, as a part of the workpiece image WI in which the melt pool MP appears, an image part of the workpiece image WI whose brightness is higher than a predetermined threshold value. Then, the control apparatus 84 calculates the size of the melt pool MP based on the size of the part of the workpiece image WI in which the melt pool MP appears.

The number of pixels constituting the workpiece image WI (alternatively, a value determined based on the number of pixels (for example, a value that is proportional to the number of pixels), the same is applied to the below-described description) may be used as the size of the melt pool MP. For example, when the size of the melt pool MP along the predetermined direction is used as the size of the melt pool MP as described above, the number of pixels in the workpiece image WI whose brightness is higher than the predetermined threshold value and which line up along the predetermined direction may be used as the size of the melt pool MP. When the area size of the melt pool MP is used as the size of the melt pool MP as described above, the number of pixels in the workpiece image WI whose brightness is higher than the predetermined threshold may be used as the size of the melt pool MP.

Then, the control apparatus 84 generates the control signal SG2 for controlling the light source 4 based on the size of the melt pool MP calculated at the step S12 (a step S13). Specifically, the control apparatus 84 sets the target intensity of the processing light EL generated by the light source 4 based on the size of the melt pool MP calculated at the step S12 and the control signal SG1 acquired from the control apparatus 7, as described above. Then, the control apparatus 84 generates the control signal SG2 for controlling the light source 4 so that the intensity of the processing light EL generated by the light source 4 is to be the target intensity set by the control apparatus 84. As a result, the light source 4 is driven based on the control signal SG2 generated by the control apparatus 84 instead of the control signal SG1 generated by the control apparatus 7. Namely, the light source 4 generates the processing light EL having the desired intensity so that the size of the melt pool MP matches the target size.

Note that the control apparatus 84 may not perform the operation illustrated in FIG. 12 in at least a part of a period during which the light source 4 does not generate the processing light EL. Namely, the control apparatus 84 may not perform the operation illustrated in FIG. 12 in at least a part of a period during which the processing head 21 does not irradiate the workpiece W with the processing light EL. In order to determine whether or not the light source 4 is generating the processing light EL, the control apparatus 84 may acquire the control signal SG1 from the control apparatus 7 and determine whether or not the light source 4 is generating the processing light EL based on the acquired control signal SG1. Alternatively, the control apparatus 84 may acquire light ON/OFF information indicating whether or not the light source 4 is generating the processing light EL from the control apparatus 7 and determine whether or not the light source 4 is generating the processing light EL based on the acquired information. Note that the light ON/OFF information may be inputted from the control apparatus 7 to the control apparatus 84 by using, for example, the fourth signal pins of the input/output connectors 87 and 88 illustrated in FIG. 10, as described above.

### (3) Technical Effect of Processing System SYS in Present Example Embodiment

As described above, in the present example embodiment, the control system 8 is attachable to the processing system SYS. Thus, the control system 8 is capable of controlling the operation of the processing system SYS based on the workpiece image WI to properly process the workpiece W. For example, the control system 8 may control the operation of the processing system SYS based on the workpiece image WI so that the size of the melt pool MP matches the target size. As a result, the processing system SYS is capable of processing the workpiece W properly, compared to a case where the workpiece W is processed in a state in which the size of the melt pool MP is significantly different from the target size.

Moreover, since the control system 8 is attachable (namely, externally attachable) to the processing system SYS, the control system 8 is allowed to be attached to the plurality of types of processing systems SYS with different standards or types. Thus, the control system 8 is capable of controlling the plurality of types of processing systems SYS with different standards or types.

Moreover, the control system 8 is capable of generating the plurality of control signals SG2 that comply with the plurality of different signal forms. Thus, the control system 8 is capable of generating control signals SG2 having the signal format suitable for the processing system SYS to which the control system 8 is attached. Thus, there is a lower possibility that the control system 8 is unable to control the processing system SYS. Namely, it is possible to ensure more opportunity for the control system 8 to control the processing system SYS.

### (4) Modified Example

Next, a modified example of the control system 8 will be described.

### (4-1) First Modified Example

In a first modified example, the control system 8 may calculate the size of the melt pool MP based on processing information related to the processing of the workpiece W in a period during which the imaging apparatus 81 captures the image of the workpiece W, in addition to the workpiece image WI. When the size of the melt pool MP is calculated based on the processing information, the control apparatus 84 may calculate the size of the melt pool MP based on the workpiece image WI, and correct (namely, change) the calculated size of the melt pool MP based on the processing information. Namely, the control apparatus 84 may provisionally calculate the size of the melt pool MP based on the workpiece image WI, and may calculate (namely, determine or fix) the size of the melt pool MP again based on the provisionally calculated size of the melt pool MP and the processing information. When the size of the melt pool MP is corrected, the control apparatus 84 may generate the control signal SG2 based on the corrected size of the melt pool MP.

Next, an operation of correcting the size of the melt pool MP based on the processing information will be described while specifically describing a specific example of the processing information.

### (4-1-1) First Specific Example of Processing Information

The moving direction information related to the moving direction of the processing light EL on the workpiece W (namely, the moving direction of the target irradiation area EA) in the period during which the imaging apparatus 81 captures the image of the workpiece W is a first specific example of the processing information. Incidentally, it can be said that the moving direction information is information related to the direction in which the relative position of the target irradiation area EA relative to the workpiece W is changed. In this case, the control apparatus 84 may calculate the size of the melt pool MP based on the workpiece image WI and the moving direction information. Specifically, the control apparatus 84 may calculate the size of the melt pool MP based on the workpiece image WI and correct the calculated size of the melt pool MP based on the moving direction information.

The control apparatus 84 may correct the calculated size of the melt pool MP by multiplying the size of the melt pool MP calculated based on the workpiece image WI by a correction coefficient determined based on the moving direction indicated by the moving direction information. For example, the control apparatus 84 may correct the size of the melt pool MP by using a first correction coefficient when the target irradiation area EA is moving toward a first moving direction on the workpiece W (namely, the relative position of the target irradiation area EA relative to the workpiece W is changed toward the first moving direction). For example, the control apparatus 84 may correct the size of the melt pool MP by using a second correction coefficient that is different from the first correction coefficient when the target irradiation area EA is moving toward a second moving direction that is different from the first moving direction on the workpiece W (namely, the relative position of the target irradiation area EA relative to the workpiece W is changed toward the second moving direction). In this case, the control apparatus 84 may be regarded to calculate (namely, correct) the size of the melt pool MP so that a method of calculating the size of the melt pool MP (namely, a correction method, and a method of generating the characteristic information) in a case where the target irradiation area EA moves toward the first moving direction is different from a method of calculating the size of the melt pool MP in a case where the target irradiation area EA moves toward the second moving direction. Note that the moving direction information may be calculated from the toolpath that is the moving trajectory of the processing head 21 (alternatively, the target irradiation area EA).

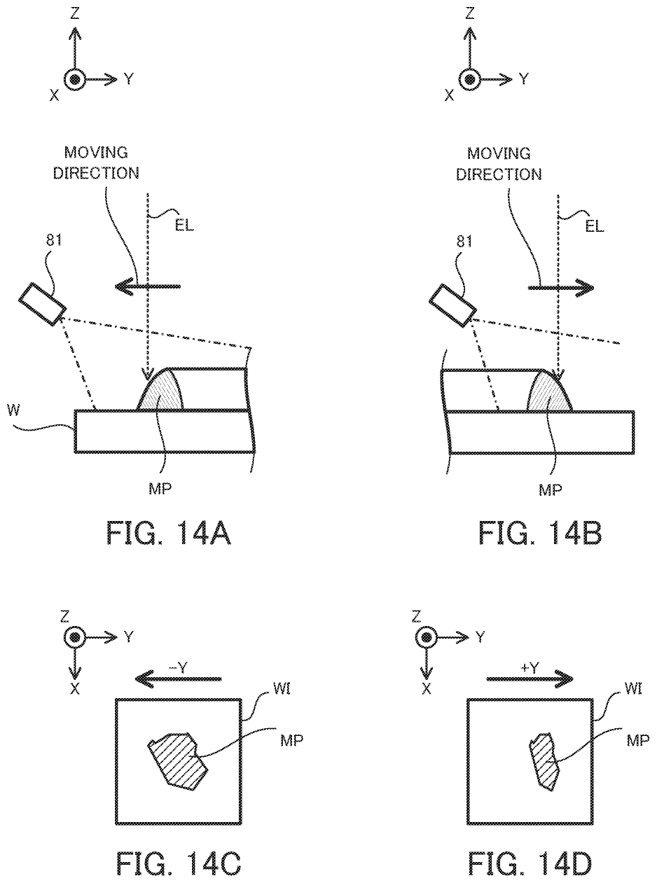

Here, with reference to FIG. 14A to FIG. 14D, a technical reason why the size of the melt pool MP is corrected based on the moving direction information will be described. FIG. 14A illustrates the imaging apparatus 81 capturing the image of the melt pool MP in a situation where a build object extending along the Y-axis direction is formed while moving the target irradiation area EA toward the −Y direction. FIG. 14B illustrates the imaging apparatus 81 capturing the image of the melt pool MP in a situation where a build object extending along the Y-axis direction is formed while moving the target irradiation area EA toward the +Y direction. In both of FIG. 14A and FIG. 14B, the imaging apparatus 81 captures the image of the melt pool MP from a position that is away from the workpiece W toward the −Y side. In this case, the target irradiation area EA moves toward a direction (namely, toward the −Y direction) that is directed from the melt pool MP toward the imaging apparatus 81 in the situation illustrated in FIG. 14A. As a result, the melt pool MP moves toward the direction that is directed from the melt pool MP toward the imaging apparatus 81. In this case, as illustrated in FIG. 14A, there is a relatively low possibility that the build object that has been already formed (namely, the build object formed by solidifying the build materials M molten in the melt pool MP) is located between the imaging apparatus 81 and the melt pool MP. On the other hand, the target irradiation area EA moves toward a direction (namely, toward the +Y direction) opposite to the direction that is directed from the melt pool MP toward the imaging apparatus 81 in the situation illustrated in FIG. 14B. As a result, the melt pool MP moves toward the direction opposite to the direction that is directed from the melt pool MP toward the imaging apparatus 81. In this case, as illustrated in FIG. 14B, there is a relatively high possibility that the build object that has been already formed is located between the imaging apparatus 81 and the melt pool MP. As a result, the size of the melt pool MP that appears in the workpiece image WI generated by the imaging apparatus 81 may be apparently smaller in the workpiece image WI in the situation illustrated in FIG. 14B, compared to the situation illustrated in FIG. 14A. Namely, even though an actual size of the melt pool MP formed in the situation illustrated in FIG. 14A matches an actual size of the melt pool MP formed in the situation illustrated in FIG. 14B, there is a possibility that the size on the workpiece image WI of the melt pool MP that appears in the workpiece image WI generated in the situation illustrated in FIG. 14B is smaller than the size on the workpiece image WI of the melt pool MP that appears in the workpiece image WI generated in the situation illustrated in FIG. 14A. This is because there is a possibility that at least a part of the melt pool MP appearing in the workpiece image WI in the situation illustrated in FIG. 14A (for example, a left side part of the melt pool MP in FIG. 14A) does not appear in the workpiece image WI in the situation illustrated in FIG. 14B. For example, FIG. 14C illustrates the workpiece image WI generated by the imaging apparatus 81 in the situation illustrated in FIG. 14A, and FIG. 14D illustrates the workpiece image WI generated by the imaging apparatus 81 in the situation illustrated in FIG. 14B. As illustrated in FIG. 14C and FIG. 14D, although the size of the melt pool MP appearing in the workpiece image WI generated in the situation illustrated in FIG. 14B should match the size of the melt pool MP appearing in the workpiece image WI generated in the situation illustrated in FIG. 14A, there is a possibility that the size of the melt pool MP appearing in the workpiece image WI generated in the situation illustrated in FIG. 14B is apparently smaller than the size of the melt pool MP appearing in the workpiece image WI generated in the situation illustrated in FIG. 14A.

In this case, there is a possibility that the control apparatus 84 erroneously determine that the apparent size of the melt pool MP calculated based on the workpiece image WI is larger or smaller than the target size, even though the actual size of the melt pool MP matches the target size. Alternatively, there is a possibility that the control apparatus 84 erroneously determine that the apparent size of the melt pool MP calculated based on the workpiece image WI matches the target size, even though the actual size of the melt pool MP does not match the target size. As a result, the actual size of the melt pool MP does not match the target size because the control signal SG2 is generated based on the result of the erroneous determination.

Thus, in the first modified example, the control apparatus 84 may correct the size of the melt pool MP based on the moving direction information. For example, the control apparatus 84 may multiply the size of the melt pool MP calculated based on the workpiece image WI by the correction coefficient that is larger than 1 so that the size of the melt pool MP calculated based on the workpiece image WI becomes larger in a situation where the apparent size of the melt pool MP calculated based on the workpiece image WI is smaller than the actual size of the melt pool MP (for example, in the situation illustrated in FIG. 14B). For example, the control apparatus 84 may multiply the size of the melt pool MP calculated based on the workpiece image WI by the correction coefficient that is smaller than 1 so that the size of the melt pool MP calculated based on the workpiece image WI becomes smaller in a situation where the apparent size of the melt pool MP calculated based on the workpiece image WI is larger than the actual size of the melt pool MP (for example, in the situation illustrated in FIG. 14A). The control apparatus 84 may multiply the size of the melt pool MP calculated based on the workpiece image WI by the correction coefficient that is equal to 1 so that the size of the melt pool MP calculated based on the workpiece image WI is maintained in a situation where the apparent size of the melt pool MP calculated based on the workpiece image WI matches the actual size of the melt pool MP. Alternatively, the control apparatus 84 may not correct the size of the melt pool MP calculated based on the workpiece image WI in the situation where the apparent size of the melt pool MP calculated based on the workpiece image WI matches the actual size of the melt pool MP. In this manner, the control apparatus 84 may correct the size of the melt pool MP calculated based on the workpiece image WI so that the apparent size of the melt pool MP calculated based on the workpiece image WI approaches or matches the actual size of the melt pool MP. As a result, the control apparatus 84 is capable of generating the control signal SG2 based on the actual size of the melt pool MP by generating the control signal SG2 based on the corrected size of the melt pool MP. Thus, the actual size of the melt pool MP actually formed on the workpiece W matches (alternatively, approaches) the target size because the workpiece W is irradiated with the processing light EL generated by the light source 4 based on this control signal SG2.

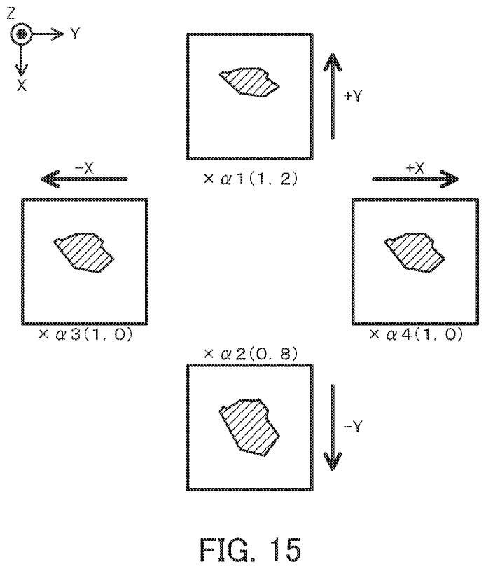

FIG. 15 illustrates an example of a relationship between the moving direction of the target irradiation area EA and the correction coefficient in a case where the imaging apparatus 81 captures the image of the melt pool MP from a position that is away from the workpiece W toward the −Y side. As illustrated in FIG. 15, for example, when the target irradiation area EA moves toward the +Y direction (namely, moves from a first Y position to a second Y position on the workpiece W, wherein a Y coordinate of the second Y position is larger than that of the first Y position), the control apparatus 84 may correct the size of the melt pool MP by using a first correction coefficient α1 (for example, a correction coefficient larger than 1). For example, when the target irradiation area EA moves toward the −Y direction (namely, moves from the second Y position to the first Y position on the workpiece W), the control apparatus 84 may correct the size of the melt pool MP by using a second correction coefficient α2 (for example, a correction coefficient that is smaller than first correction coefficient α1, and a correction coefficient smaller than 1 as one example). For example, when the target irradiation area EA moves toward the +X direction (namely, moves from a first X position to a second X position on the workpiece W, wherein a X coordinate of the second X position is larger than that of the first X position), the control apparatus 84 may correct the size of the melt pool MP by using a third correction coefficient α3 (for example, a correction coefficient that smaller than the first correction coefficient α1 and larger than the second correction coefficient α2, and a correction coefficient equal to 1 as one example). For example, when the target irradiation area EA moves toward the −X direction (namely, moves from the second X position to the first X position on the workpiece W), the control apparatus 84 may correct the size of the melt pool MP by using a fourth correction coefficient α4 (for example, a correction coefficient that smaller than the first correction coefficient α1 and larger than the second correction coefficient α2, and a correction coefficient equal to 1 as one example).

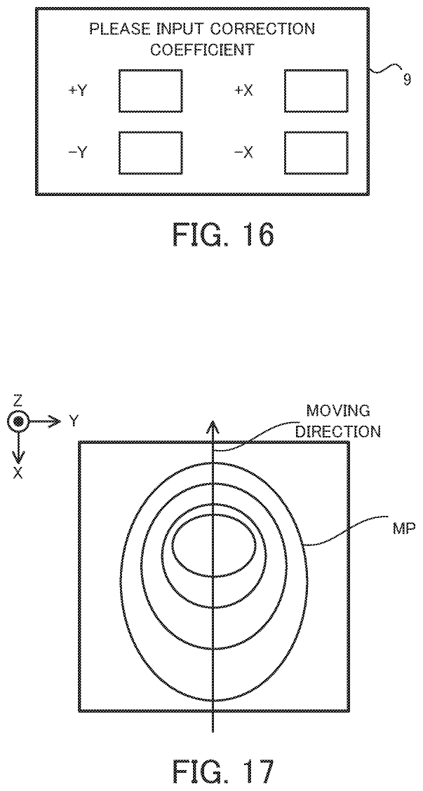

A relationship between the moving direction of the target irradiation area EA and the apparent size of the melt pool MP calculated based on the workpiece image WI may be calculated and the correction coefficients may be set in advance based on the calculated relationship. Alternatively, the correction coefficient may be set by the user of the processing system SYS. When the correction coefficient is set by the user, the control apparatus 84 (alternatively, the control apparatus 7) may control the display 9 to display a GUI (Graphic User Interface) for setting the correction coefficient, as illustrated in FIG. 16. When the correction coefficient is set by the user, the control apparatus 84 (alternatively, the control apparatus 7) may control the display 9 to display the workpiece image WI. In this case, the user may set the correction coefficient while referring to the workpiece image WI.

In order to calculate the size of the melt pool MP based on the moving direction information, the control apparatus 84 may acquire the moving direction information. For example, the control apparatus 84 may acquire the moving direction information from the control apparatus 7 by using the input port 85 (for example, by using the fifth pins of the input/output connectors 87 and 88 illustrated in FIG. 10), as described above. Alternatively, the control apparatus 84 may generate the moving direction information based on the workpiece image WI. For example, as illustrated in FIG. 17 that illustrates the melt pool MP appearing in the workpiece image WI, the melt pool MP appears in the workpiece image WI so that a part irradiated with the processing light EL (especially, its center) is the brightest and the melt pool MP becomes darker as it is farther from the part irradiated with the processing light EL. As a result, the melt pool MP appears in the workpiece image WI so that the gradation changes monotonously as it is farther from the part irradiated with the processing light EL. Here, when the workpiece W is irradiated with the processing light EL while the target irradiation area EA is moving, a change aspect of the gradation of the melt pool MP at a front side along the moving direction of the target irradiation area EA from the part of the melt pool MP that is irradiated with the processing light EL is different from a change aspect of the gradation of the melt pool MP at a rear side along the moving direction of the target irradiation area EA from the part of the melt pool MP that is irradiated with the processing light EL. Specifically, as illustrated in FIG. 17, there is a high possibility that the part (namely, the brightest part) of the melt pool MP that is irradiated with the processing light EL appears in the workpiece image WI so that it is located at a position that is away from the center of the melt pool MP (specifically, an outline of the melt pool MP) toward the front side along the moving direction of the target irradiation area EA. Thus, the workpiece image WI includes the information related to the moving direction of the target irradiation area EA. Namely, the control apparatus 84 is capable of generating the moving direction information based on the workpiece image WI.

For example, a plurality of pixels constituting the melt pool MP appearing in the workpiece image WI have a gradation value corresponding to the brightness of the melt pool MP. Thus, the control apparatus 84 may generate the moving direction information based on the gradation values of the plurality of pixels constituting the melt pool MP appearing in the workpiece image WI. For example, the control apparatus 84 may repeat an operation for calculating a center of mass of an area including pixels having the gradation value larger than a predetermined threshold value a plurality of times while changing the threshold value, and may calculate, as the moving direction of the target irradiation area EA, a direction along which the calculated plurality of centers of mass are connected in an ascending order of the threshold value (namely, a direction directed from the center of mass corresponding to the smallest threshold value to the center of mass corresponding to the largest threshold value). For example, the control apparatus 84 may repeat an operation of calculating the area including pixels having the gradation value larger than the predetermined threshold value a plurality of times while changing the threshold value, and may calculate, as the moving direction of the target irradiation area EA, a direction directed from a part at which an interval between edges of the plurality of areas is largest to a part at which the interval between the edges of the plurality of areas is smallest.

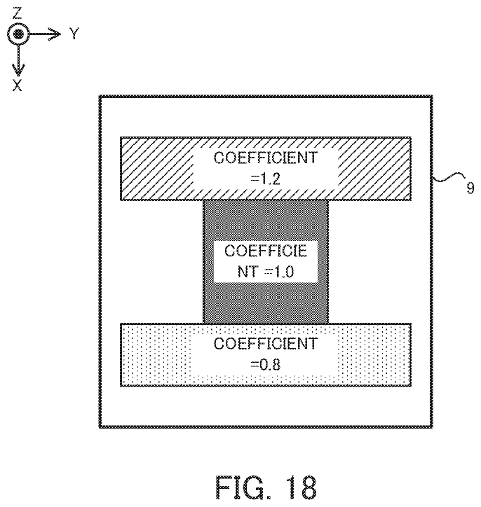

When the size of the melt pool MP is corrected by using the correction coefficient, the control apparatus 84 (alternatively, the control apparatus 7) may control the display 9 to display an image including the three-dimensional structural object ST in a display aspect in which the applied correction coefficients are distinguishable from each other after the three-dimensional structural object ST is formed, as illustrated in FIG. 18. For example, the control apparatus 84 (alternatively, the control apparatus 7) may control the display 9 to display an image including the three-dimensional structural object ST in a display aspect in which a part that is formed by irradiating it with the processing light EL controlled by the control signal SIG2 to which a first correction coefficient has been applied and a part that is formed by irradiating it with the processing light EL controlled by the control signal SIG2 to which the second correction coefficient is applied.

### (4-1-2) Second Specific Example of Processing Information

Angle information related to an angle of the stage 31 (for example, an angle of the placement surface 311 of the stage 31 relative to the optical axis AX of the irradiation optical system 211, and it may be referred to as a tilt angle) in the period during which the imaging apparatus 81 captures the image of the workpiece W is a second specific example of processing information. In this case, the control apparatus 84 may calculate the size of the melt pool MP based on the angle information by a method that is same as a method of calculating the size of the melt pool MP based on the moving direction information. Namely, the control apparatus 84 may calculate the size of the melt pool MP based on the workpiece image WI and correct the calculated size of the melt pool MP based on the angle information.

The control apparatus 84 may correct the calculated size of the melt pool MP by multiplying the size of the melt pool MP calculated based on the workpiece image WI by a correction coefficient determined based on the angle of the stage 31 indicated by the angle information. For example, the control apparatus 84 may correct the size of the melt pool MP by using a first correction coefficient when the angle of the stage 31 is a first angle. For example, the control apparatus 84 may correct the size of the melt pool MP by using a second correction coefficient that is different from the first correction coefficient when the angle of the stage 31 is a second angle that is different from the first angle. In this case, the control apparatus 84 may be regarded to calculate (namely, correct) the size of the melt pool MP so that a method of calculating the size of the melt pool MP (namely, a correction method, and a method of generating the characteristic information) in a case where the angle of the stage 31 is the first angle is different from a method of calculating the size of the melt pool MP in a case where the angle of the stage 31 is the first angle.

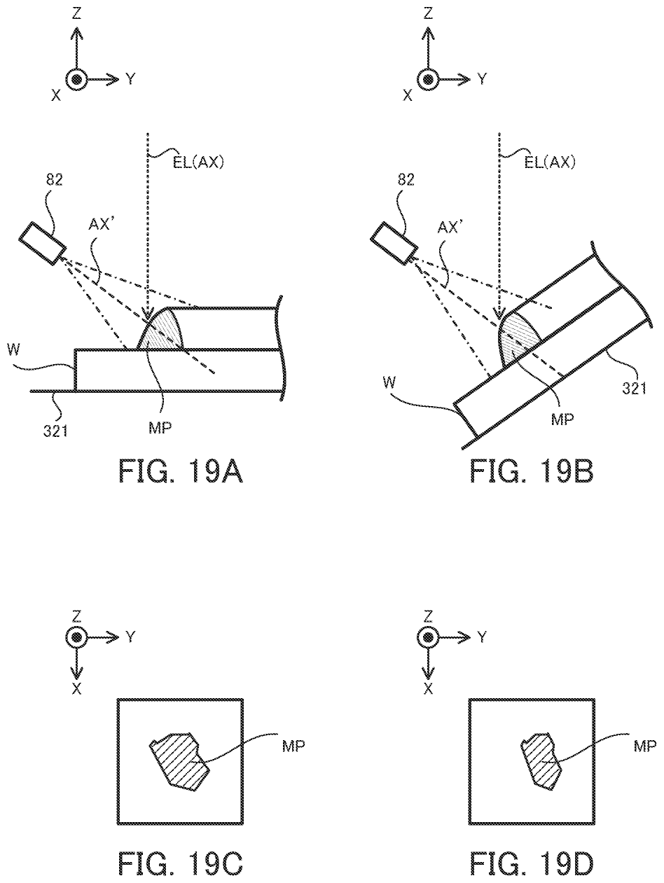

Here, with reference to FIG. 19A to FIG. 19D, a technical reason why the size of the melt pool MP is corrected based on the angle information will be described. FIG. 19A illustrates the imaging apparatus 81 capturing the image of the melt pool MP in a situation where the placement surface 311 is perpendicular to the optical axis AX (namely, the angle of the stage 31 is 90 degree). FIG. 19B illustrates the imaging apparatus 81 capturing the image of the melt pool MP in a situation where the placement surface 311 is inclined with respect to the optical axis AX (namely, the angle of the stage 31 is smaller than 90 degree). In both of FIG. 19A and FIG. 19B, the imaging apparatus 81 captures the image of the melt pool MP from a position that is away from the workpiece W toward the −Y side. In this case, as illustrated in FIG. 19A and FIG. 19B, a positional relationship between the imaging apparatus 81 and the melt pool MP in the situation illustrated in FIG. 19A is different from the positional relationship between the imaging apparatus 81 and the melt pool MP in the situation illustrated in FIG. 19B. Thus, although the size of the melt pool MP appearing in the workpiece image WI generated in the situation illustrated in FIG. 19B should match the size of the melt pool MP appearing in the workpiece image WI generated in the situation illustrated in FIG. 19A, there is a possibility that the size of the melt pool MP appearing in the workpiece image WI generated in the situation illustrated in FIG. 19B is apparently larger or smaller than the size of the melt pool MP appearing in the workpiece image WI generated in the situation illustrated in FIG. 19A. Note that FIG. 19C illustrates the workpiece image WI generated by the imaging apparatus 81 in the situation illustrated in FIG. 19A, and FIG. 19D illustrates the workpiece image WI generated by the imaging apparatus 81 in the situation illustrated in FIG. 19B.

Thus, the control apparatus 84 may correct the size of the melt pool MP based on the angle information, as with a case where the size of the melt pool MP is corrected based on the moving direction information. Namely, the control apparatus 84 may correct the size of the melt pool MP calculated based on the workpiece image WI so that the apparent size of the melt pool MP calculated based on the workpiece image WI approaches or matches the actual size of the melt pool MP. As a result, the control apparatus 84 is capable of generating the control signal SG2 based on the actual size of the melt pool MP by generating the control signal SG2 based on the corrected size of the melt pool MP. Thus, the actual size of the melt pool MP actually formed on the workpiece W matches (alternatively, approaches) the target size because the workpiece W is irradiated with the processing light EL generated by the light source 4 based on this control signal SG2.

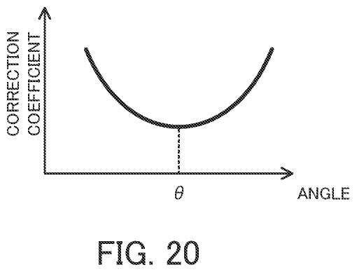

FIG. 20 illustrates an example of a relationship between the angle of the stage 31 and the correction coefficient. Generally, there is the highest possibility that the size of the melt pool MP appearing in the workpiece image WI (namely, the apparent size of the melt pool MP calculated by the control apparatus 84) matches the actual size of the melt pool MP when the angle of the stage 31 is a predetermined angle θ (for example, an angle when the placement surface 311 is perpendicular to the optical axis AX, and 90°). Moreover, there is a high possibility that the size of the melt pool MP appearing in the workpiece image WI is smaller as a difference between the angle of the stage 31 and the predetermined angle θ is larger. Thus, the control apparatus 84 may correct the size of the melt pool MP calculated by the control apparatus 84 by using a correction coefficient that is the smallest when the angle of the stage 31 is the predetermined angle θ and that is the largest when the difference between the angle of the stage 31 and the predetermined angle θ increases.

A relation between the angle of the stage 31 and the apparent size of the melt pool MP calculated based on the workpiece image WI may be calculated, and the correction coefficient may be set in advance based on the calculated relationship. Alternatively, the correction coefficient may be set by the user of the processing system SYS. In this case, a GUI for setting the correction coefficient may be displayed on the display 9, as with a case where the correction coefficient is set based on the moving direction information.

In order to calculate the size of the melt pool MP based on the angle information, the control apparatus 84 may acquire the angle information. For example, the control apparatus 84 may acquire the angle information from the control apparatus 7 by using the input port 85 (for example, by using the seventh signal pins of the input/output connectors 87 and 88 illustrated in FIG. 10), as described above. Note that control information for controlling the stage driving system 32 configured to move the stage 31 may be used as the angle information. Alternatively, when the stage apparatus 3 includes a position measurement apparatus for measuring the position of the stage 31, information related to a measured result by the position measurement apparatus may be used as the angle information.

### (4-1-3) Third Specific Example of Processing Information

Shape information related to a shape of an existing build object formed on the workpiece W (note that the existing build object may include at least a part of the workpiece W) in the period during which the imaging apparatus 81 captures the image of the workpiece W is a third specific example of processing information. In this case, the control apparatus 84 may calculate the size of the melt pool MP based on the shape information by a method that is same as the method of calculating the size of the melt pool MP based on the moving direction information. Namely, the control apparatus 84 may calculate the size of the melt pool MP based on the workpiece image WI, and correct the calculated size of the melt pool MP based on the shape information.

The control apparatus 84 may correct the calculated size of the melt pool MP by multiplying the size of the melt pool MP calculated based on the workpiece image WI by a correction coefficient determined based on the shape of the existing build object indicated by the shape information. For example, the control apparatus 84 may correct the size of the melt pool MP by using the a first correction coefficient when the shape of the existing build object is a first shape. For example, the control apparatus 84 may correct the size of the melt pool MP by using a second correction coefficient that is different from the first correction coefficient when the shape of the existing build object is a second shape different from the first shape. In this case, the control apparatus 84 may be regarded to calculate (namely, correct) the size of the melt pool MP so that a method of calculating the size of the melt pool MP (namely, a correction method, and a method of generating the characteristic information) in a case where the shape of the existing build object is the first shape is different from a method of calculating the size of the melt pool MP in a case where the shape of the existing build object is the second shape.

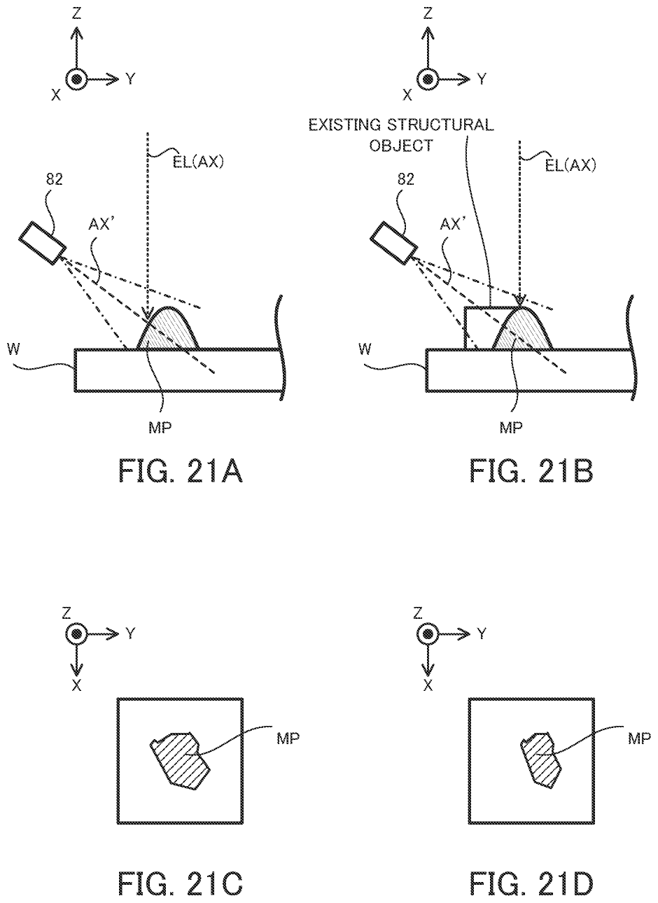

Here, with reference to FIG. 21A to FIG. 21D, a technical reason why the size of the melt pool MP is corrected based on the shape information will be described. FIG. 21A illustrates the imaging apparatus 81 capturing the image of the melt pool MP in a situation where one build object extending along the X-axis direction is formed while moving the target irradiation area EA along the X-axis direction. FIG. 21B illustrates the imaging apparatus 81 capturing the image of the melt pool MP in a situation where another build object extending along the X-axis direction is formed at a position adjacent to the +Y side of the one build object extending along the X-axis direction while moving the target irradiation area EA along the X-axis direction. In both of FIGS. 21A and 21B, the imaging apparatus 81 captures the image of the melt pool MP from a position that is away from the workpiece toward the −Y side. In this case, there is a relatively high possibility that the build object that has been already formed is located between the imaging apparatus 81 and the melt pool MP in the situation illustrated in FIG. 21B. Thus, although the size of the melt pool MP appearing in the workpiece image WI generated in the situation illustrated in FIG. 21B should match the size of the melt pool MP appearing in the workpiece image WI generated in the situation illustrated in FIG. 21A, there is a possibility that the size of the melt pool MP appearing in the workpiece image WI generated in the situation illustrated in FIG. 19B is apparently larger or smaller than the size of the melt pool MP appearing in the workpiece image WI generated in the situation illustrated in FIG. 19A. Note that FIG. 21C illustrates the workpiece image WI generated by the imaging apparatus 81 in the situation illustrated in FIG. 21A, and FIG. 21D illustrates the workpiece image WI generated by the imaging apparatus 81 in the situation illustrated in FIG. 21B.

Thus, the control apparatus 84 may correct the size of the melt pool MP based on the shape information, as with a case where the size of the melt pool MP is corrected based on the moving direction information. Namely, the control apparatus 84 may correct the size of the melt pool MP calculated based on the workpiece image WI so that the apparent size of the melt pool MP calculated based on the workpiece image WI approaches or matches the actual size of the melt pool MP. As a result, the control apparatus 84 is capable of generating the control signal SG2 based on the actual size of the melt pool MP by generating the control signal SG2 based on the corrected size of the melt pool MP. Thus, the actual size of the melt pool MP actually formed on the workpiece W matches (alternatively, approaches) the target size because the workpiece W is irradiated with the processing light EL generated by the light source 4 based on this control signal SG2.

A relation between the shape of the existing build object and the apparent size of the melt pool MP calculated based on the workpiece image WI may be calculated, and the correction coefficient may be set in advance based on the calculated relationship. Alternatively, the correction coefficient may be set by the user of the processing system SYS. In this case, a GUI for setting the correction coefficient may be displayed on the display 9, as with a case where the correction coefficient is set based on the moving direction information.

In order to calculate the size of the melt pool MP based on the shape information, the control apparatus 84 may acquire the shape information. For example, the control apparatus 84 may acquire the shape information from the control apparatus 7 by using the input port 85 (for example, by using the eighth signal pins of the input/output connectors 87 and 88 illustrated in FIG. 10), as described above. Incidentally, the shape information related to the shape of the existing build object is known information to the control apparatus 7, because the processing system SYS performs the additional processing under the control of the control apparatus 7,

### (4-2) Second Modified Example

In the above-described first modified example, the control apparatus 84 calculates the size of the melt pool MP based on the workpiece image WI, and corrects the calculated size of the melt pool MP based on the processing information. On the other hand, in a second modified example, the control apparatus 84 may correct the workpiece image WI based on the processing information, and calculate the size of the melt pool MP based on the corrected workpiece image WI. For example, the control apparatus 84 may correct the workpiece image WI so that a method of correcting the workpiece image WI in a case where the target irradiation area EA moves toward the first moving direction is different from a method of correcting the workpiece image WI in a case where the target irradiation area EA moves toward the second moving direction. For example, the control apparatus 84 may correct the workpiece image WI so that a method of correcting the workpiece image WI in a case where the angle of the stage 31 is the first angle is different from a method of correcting the workpiece image WI in a case where the angle of the stage 31 is the second angle. For example, the control apparatus 84 may correct the workpiece image WI so that a method of correcting the workpiece image WI in a case where the shape of the existing build object is the first shape is different from a method of correcting the workpiece image WI in a case where the shape of the existing build object is the second shape.

Specifically, for example, the control apparatus 84 may correct the workpiece image WI so that the size of the melt pool MP appearing in the workpiece image WI becomes larger in a situation where the apparent size of the melt pool MP appearing in the workpiece image WI is smaller than the actual size of the melt pool MP. For example, the control apparatus 84 may correct the workpiece image WI so that the size of the melt pool MP appearing in the workpiece image WI becomes smaller in a situation where the apparent size of the melt pool MP appearing in the workpiece image WI is larger than the actual size of the melt pool MP. For example, the control apparatus 84 may not correct the workpiece image WI in a situation where the apparent size of the melt pool MP in the workpiece image WI matches the actual size of the melt pool MP. Namely, the control apparatus 84 may correct the workpiece image WI so that the apparent size of the melt pool MP appearing in the workpiece image WI approaches or matches the actual size of the melt pool MP.

As a result, the size of the melt pool MP calculated based on the corrected workpiece image WI approaches or matches the actual size of the melt pool MP, as with the size of the melt pool MP corrected in the above-described first modified example. As a result, the control apparatus 84 is capable of generating the control signal SG2 based on the actual size of the melt pool MP, as in the first modified example. Thus, an effect that is the same as the effect achievable in the first modified example is also achievable in the second modified example.

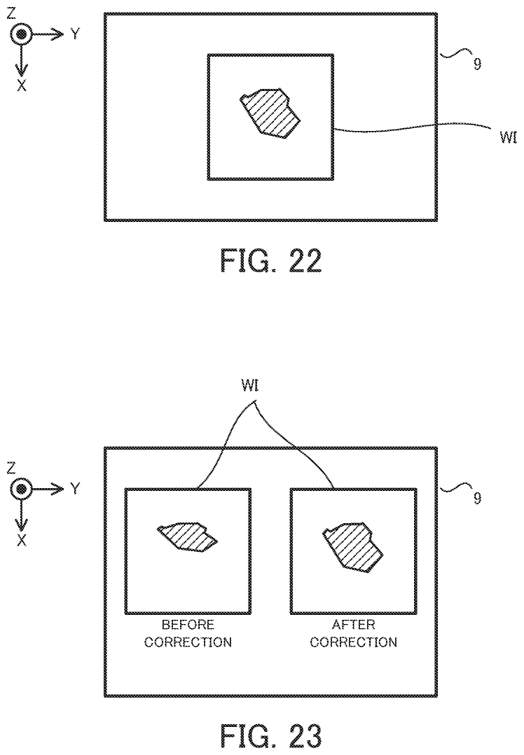

When the workpiece image WI is corrected, the control apparatus 84 (alternatively, the control apparatus 7) may control the display 9 to display the corrected workpiece image WI, as illustrated in FIG. 22. In this case, as illustrated in FIG. 23, the control apparatus 84 (alternatively, the control apparatus 7) may control the display 9 to display the corrected workpiece image WI together with the workpiece image WI that has not been corrected yet. As a result, the user can understand how the workpiece image WI has been corrected. The control apparatus 84 may also control the display 9 to display the newly generated and corrected workpiece image WI each time the imaging apparatus 81 generates a new workpiece image WI. Namely, the control apparatus 84 may display the workpiece image WI in real time. The control apparatus 84 may sequentially display a plurality of workpiece images WI (what we call, a plurality of workpiece images WI used as a video) that are switched each time the imaging apparatus 81 generates a new workpiece image WI. Alternatively, the control apparatus 84 may store the corrected workpiece image WI in a non-illustrated storage apparatus. In this case, the control apparatus 84 may read the workpiece image WI from the storage apparatus at a desired timing (for example, at a timing desired by the user) and control the display 9 to display the read workpiece images WI.

### (4-3) Third Modified Example

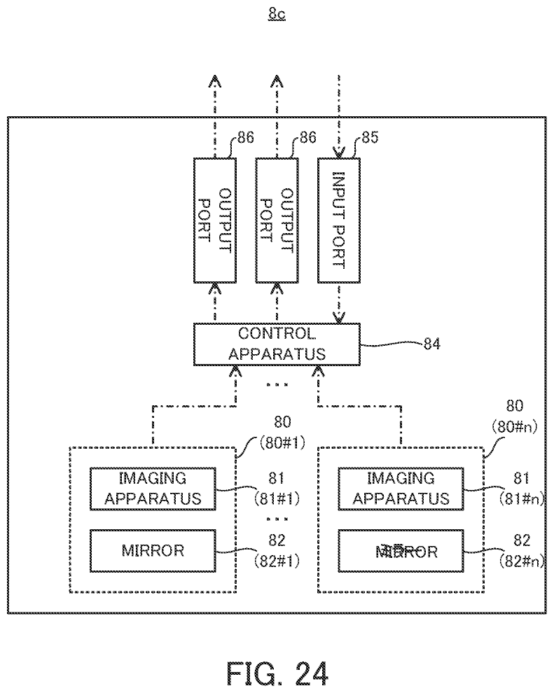

Next, with reference to FIG. 24, the control system 8 in a third modified example will be described. FIG. 24 is a system configuration diagram that illustrates the system configuration of the control system 8 in the third modified example. In the below-described description, the control system 8 in the third modified example is referred to as a “control system 8c”.

As illustrated in FIG. 24, the control system 8c in the third modified example is different from the above-described control system 8 in that it may include a plurality of imaging heads 80. Other feature of the control system 8c may be same as other feature of the control system 8. Incidentally, in the below-described description, an example in which the control system 8c includes n (note that n is a constant representing an integer that is larger than or equal to 2) imaging heads 80 will be described. In this case, the k-th (note that k is a variable number representing an integer satisfying 1≤k≤n) imaging head 80 of the n imaging heads 80 is referred to as the “imaging head 80 #k”. Moreover, the imaging apparatus 81 and the mirror 82 of the imaging head 80 #k are referred to as the imaging apparatus 81 #k and the mirror 82 #k, respectively.

The plurality of imaging heads 80 are attachable to the processing head 21 so that relative positions of the plurality of imaging heads 80 relative to the workpiece W are different from each other. Namely, the plurality of imaging heads 80 are attachable to the processing head 21 so that the positional relationships between the workpiece W and the plurality of imaging heads 80 are different from each other. In this case, the plurality of imaging heads 80 are configured to capture the image of the workpiece W from different directions, respectively. For example, the imaging head 80 #1 is configured to capture the image of the workpiece W from a first direction, the imaging head 80 #2 is configured to capture the image of the workpiece W from a second direction that is different from the first direction, . . . , the imaging head 80 #n−1 is configured to capture the image of the workpiece W from a [n−1]-th direction that is different from the first direction to a [n−2]-th direction, and the imaging head 80 #n is configured to capture the image of the workpiece W from a n-th direction that is different from the first direction to the [n−1]-th direction.

In the third modified example, the control apparatus 84 may control the operation of the processing system SYS based on the plurality of workpiece images WI generated by the plurality of imaging apparatuses 81, respectively, and the processing information (for example, the moving direction information, the angle information, and the shape information described in the first modified example). The control apparatus 84 may control the operation of the processing system SYS based on the workpiece image WI generated by at least one of the plurality of imaging apparatuses 81 and the processing information.

Specifically, as described in the first modified example, although the size of the melt pool MP appearing in the workpiece image WI generated in the situation where the target irradiation area EA moves toward the first moving direction should match the size of the melt pool MP appearing in the workpiece image WI generated in the situation where the target irradiation area EA moves toward the second moving direction, there is a possibility that the sizes of the melt pools MP appearing in these two workpiece images WI does not match apparently as described above. Similarly, although the size of the melt pool MP appearing in the workpiece image WI generated in the situation where the angle of the stage 31 is the first angle should match the size of the melt pool MP appearing in the workpiece image WI generated in the situation where the angle of the stage 31 is the second angle, there is a possibility that the sizes of the melt pools MP appearing in these two workpiece images WI does not match apparently as described above. Similarly, although the size of the melt pool MP appearing in the workpiece image WI generated in the situation where the shape of the existing build object is the first shape should match the size of the melt pool MP appearing in the workpiece image WI generated in the situation where the shape of the existing build object is the second shape, there is a possibility that the sizes of the melt pools MP appearing in these two workpiece images WI does not match apparently as described above. When the plurality of imaging apparatuses 81 capture the images of the workpiece W from the different directions, respectively, in these situations, there is a possibility that the apparent size of the melt pool MP appearing in the workpiece image WI generated by one imaging apparatus 81 of the plurality of imaging apparatuses 81 matches the actual size of the melt pool MP (alternatively, a difference between both sizes is relatively small) while and the apparent size of the melt pool MP appearing in the workpiece image WI generated by other imaging apparatus 81 of the plurality of imaging apparatuses 81 is different from the actual size of the melt pool MP (alternatively, the difference between both sizes is relatively large).

Thus, in the third modified example, the control apparatus 84 may select at least one of the plurality of imaging apparatuses 81 based on the processing information, and calculate the size of the melt pool MP based on the workpiece image WI generated by the selected at least one imaging apparatus 81. Specifically, the control apparatus 84 may select, based on the processing information, at least one imaging apparatus 81, which is capable of generating the workpiece image WI in which the melt pool MP having the size matching the actual size (alternatively, the melt pool MP having the size whose difference from the actual size is relatively small) is expected to appear, from the plurality of imaging apparatuses 81, and calculate the size of the melt pool MP based on the workpiece image WI generated by the selected at least one imaging apparatus 81. Alternatively, the control apparatus 84 may select at least one of the plurality of workpiece images WI captured by the plurality of imaging apparatuses 81, respectively, based on the processing information, and calculate the size of the melt pool MP based on the selected at least one workpiece image WI. Specifically, the control apparatus 84 may select, based on the processing information, at least one workpiece image WI, in which the melt pool MP having the size matching the actual size (alternatively, the melt pool MP having the size whose difference from the actual size is relatively small) is expected to appear, from the plurality of workpiece images WI captured by the plurality of imaging apparatuses 81, respectively, and calculate the size of the melt pool MP based on the selected at least one workpiece image WI.

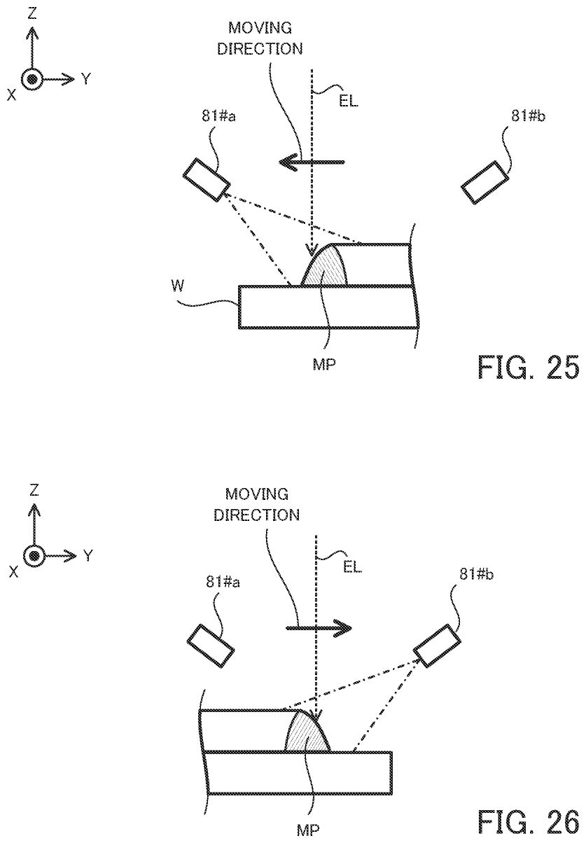

As one example, for example, an example in which the control system 8 includes the imaging apparatus 81 #a (note that a is a variable number representing an integer satisfying 1≤a≤n) that is configured to capture the image of the melt pool MP from a position that is away from the workpiece W toward the −Y side and the imaging apparatus 81 #b (note that b is a variable number representing an integer satisfying 1≤b≤n) that is configured to capture the image of the melt pool MP from a position that is away from the workpiece W toward the +Y side will be described. As illustrated in FIG. 25, when the processing system SYS forms the build object extending in the Y-axis direction while moving the target irradiation area EA toward the −Y direction, the control apparatus 84 may calculate the size of the melt pool MP by using the workpiece image WI generated by the imaging apparatus 81 #a that has a relatively low possibility of the formed build object being located between the melt pool MP and itself. As illustrated in FIG. 26, when the processing system SYS forms the build object extending in the Y-axis direction while moving the target irradiation area EA toward the +Y direction, the control apparatus 84 may calculate the size of the melt pool MP by using the workpiece image WI generated by the imaging apparatus 81 #b that has a relatively low possibility of the formed build object being located between the melt pool MP and itself. Namely, as illustrated in FIG. 25 and FIG. 26, the control apparatus 84 may calculate the size of the melt pool MP based on the workpiece image WI generated by the imaging apparatus 81 located ahead of the melt pool MP along the moving direction of the target irradiation area EA.

The size of the melt pool MP calculated based on the workpiece image WI that is generated by at least one imaging apparatus 81 selected based on the processing information may be regarded to be substantially equivalent to the size of the melt pool MP in the first modified example that is corrected based on the processing information. As a result, an effect that is the same as the effect achievable in the first modified example is also achievable in the second modified example.

### (4-4) Fourth Modified Example

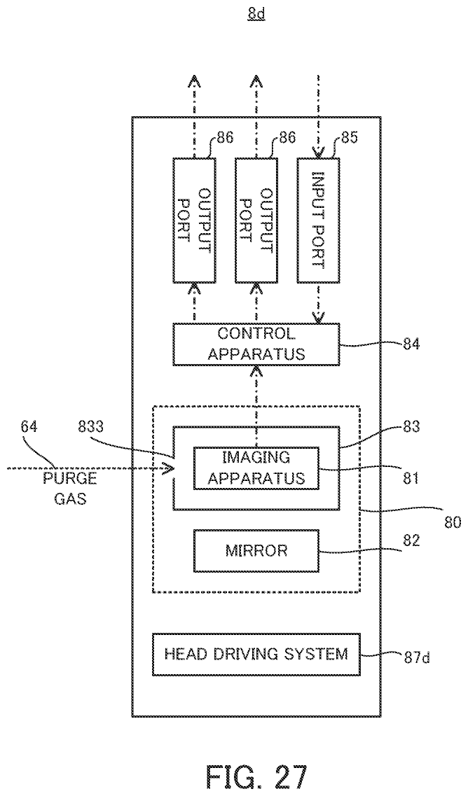

Next, with reference to FIG. 27, the control system 8 in a fourth modified example will be described. FIG. 27 is a system configuration diagram that illustrates the system configuration of the control system 8 in the fourth modified example. In the below-described description, the control system 8 in the fourth modified example is referred to as a “control system 8d”.

As illustrated in FIG. 27, the control system 8d in the fourth modified example is different from the above-described control system 8 in that it may include a head driving system 87d. Other feature of the control system 8d may be same as other feature of the control system 8.

The head driving system 87d is configured to move the imaging head 80. The head driving system 87d may move the imaging head 80 along at least one of the X-axis, the Y-axis, the Z-axis, the θX direction, the θY direction, and the θZ direction, for example. The head driving system 87d may move the imaging head 80 around the processing head 21. Since the imaging head 80 includes the imaging apparatus 81 and the mirror 82, when the head driving system 87d moves the imaging head 80, the imaging apparatus 81 and the mirror 82 also move. Thus, the head driving system 87d may be regarded as a driving system that is configured to move the imaging apparatus 81 and the mirror 82 simultaneously. The head driving system 87d may be regarded as a change apparatus that is configured to change a position of each of the imaging head 80, the imaging apparatus 81 and the mirror 82 by moving the imaging head 80.

The head driving system 87d may move at least one of the imaging apparatus 81 and the mirror 82 in addition to or instead of moving the imaging head 80. The head driving system 87d may move at least one of the imaging apparatus 81 and the mirror 82 along at least one of the X-axis, the Y-axis, the Z-axis, the θX direction, the θY direction, and the θZ direction, for example. The head driving system 87d may move at least one of the imaging apparatus 81 and the mirror 82 around the processing head 21. A moving distance of the imaging apparatus 81 may be same as or different from a moving distance of the mirror 82. A moving direction of the imaging apparatus 81 may be same as or different from a moving direction of the mirror 82. In this case, the head driving system 87d may be regarded as a change apparatus that is configured to change a position of at least one of the imaging apparatus 81 and the mirror 82 by moving at least one of the imaging apparatus 81 and the mirror 82.

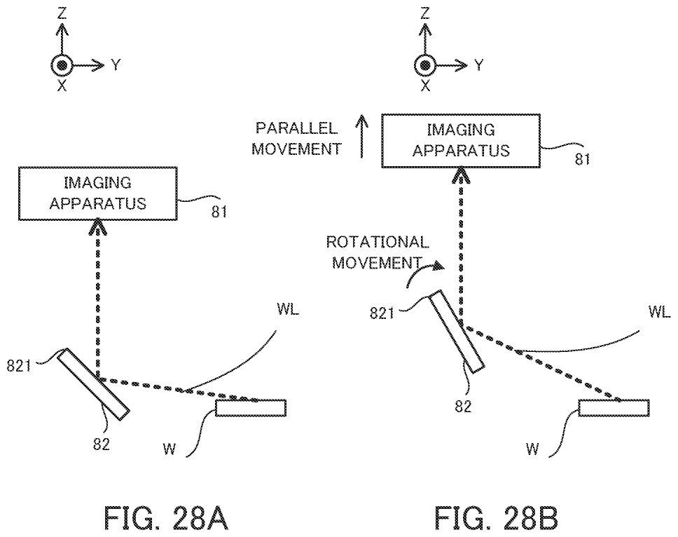

The head driving system 87d may move at least one of the imaging head 80, the imaging apparatus 81 and the mirror 82 so that the workpiece light WL from the workpiece W reaches the imaging apparatus 81 through the mirror 82. For example, FIG. 28A illustrates the imaging apparatus 81 and the mirror 82 before movement, and FIG. 28B illustrates the imaging apparatus 81 that has moved along the Z-axis and the mirror 82 that has rotated around the X-axis. As illustrated in FIG. 28A and FIG. 28B, the head driving system 87d may move at least one of the imaging head 80, the imaging apparatus 81 and the mirror 82 so that the imaging apparatus 81 is capable of optically receiving the workpiece light WL not only before the head driving system 87d moves at least one of the imaging apparatus 81 and the mirror 82, but also after the head driving system 87d moves the imaging apparatus 81 and the mirror 82.

The head driving system 87d may move at least one of the imaging head 80, the imaging apparatus 81 and the mirror 82 so that a length of the optical path of the workpiece light WL between the workpiece W and the imaging apparatus 81 is kept constant. In this case, even when at least one of the imaging head 80, the imaging apparatus 81 and the mirror 82 moves, the workpiece light WL can form an image on an imaging surface of the imaging element of the imaging apparatus 81. Namely, the imaging apparatus 81 is capable of generating the workpiece image WI in which the workpiece W is properly appears by optically receiving the workpiece light WL. However, the head driving system 87d may move at least one of the imaging head 80, the imaging apparatus 81 and the mirror 82 so that the length of the optical path of the workpiece light WL between the workpiece W and the imaging apparatus 81 changes. In this case, the imaging head 80 may include an optical system that is configured to condense the workpiece light WL (especially, form the image) on the imaging surface so that the workpiece light WL can form the image on the imaging surface of the imaging element even when the length of the optical path of the workpiece light WL changes.

When the head driving system 87d moves at least one of the imaging head 80, the imaging apparatus 81 and the mirror 82, the relative position of at least one of the imaging head 80, the imaging apparatus 81 and the mirror 82 relative to the workpiece W changes. Namely, a direction in which the imaging apparatus 81 captures the image of the workpiece W changes. In the fourth modified example, the control apparatus 84 may move at least one of the imaging head 80, the imaging apparatus 81 and the mirror 82 so that the imaging apparatus 81 is capable of capturing the image of the workpiece W from a desired direction by controlling the head driving system 87d. Especially, in the fourth modified example, the control apparatus 84 move at least one of the imaging head 80, the imaging apparatus 81 and the mirror 82 by controlling the head driving system 87d based on the processing information (for example, the moving direction information, the angle information and the shape information described in the first modified example) so that the imaging apparatus 81 is capable of capturing the image of the workpiece W from the desired direction. Specifically, the control apparatus 84 move at least one of the imaging head 80, the imaging apparatus 81 and the mirror 82 based on the processing information so that the imaging apparatus 81 is capable of generating the workpiece image WI in which the melt pool MP having the size matching the actual size (alternatively, the melt pool MP having the size whose difference from the actual size is relatively small) is expected to appear.

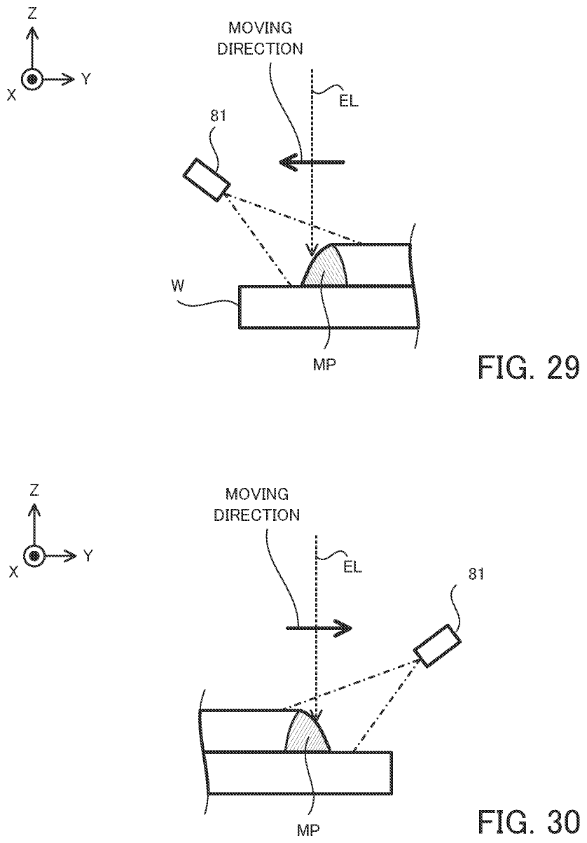

For example, as illustrated in FIG. 29, when the processing system SYS forms the build object extending in the Y-axis direction while moving the target irradiation area EA toward the −Y direction, the control apparatus 84 may move the imaging apparatus 81 to capture the image of the melt pool MP from a position that is away from the workpiece W toward the −Y side. On the other hand, as illustrated in FIG. 30, when the processing system SYS forms the build object extending in the Y-axis direction while moving the target irradiation area EA toward the +Y direction, the control apparatus 84 may move the imaging apparatus 81 to capture the image of the melt pool MP from a position that is away from the workpiece W toward the +Y side. Namely, as illustrated in FIG. 29 and FIG. 30, the control apparatus 84 may move the imaging apparatus 81 so that the imaging apparatus 81 is located ahead of the melt pool MP along the moving direction of the target irradiation area EA. As a result, the imaging apparatus 81 is capable of capturing the image of the melt pool MP in a state where there is a relatively low possibility that the build object that has been already formed is located between the imaging apparatus 81 and the melt pool MP.

The size of the melt pool MP calculated based on the workpiece image WI generated by the imaging apparatus 81 that has moved based on the processing information may be regarded to be equivalent to the size of the melt pool MP in the third modified example calculated based on the workpiece image WI that is generated by at least one imaging apparatus 81 selected based on the processing information (namely, the size of the melt pool MP in the first modified example corrected based on the processing information). As a result, an effect that is the same as the effect achievable in the third modified example is also achievable in the fourth modified example.

### (4-5) Other Modified Example

In the above-described description, the imaging head 80 is attachable to the processing head 21. However, the imaging head 80 may be attachable to a member that is different from the processing head 21. For example, the imaging head 80 may be attachable to at least a part of the processing apparatus 2. For example, the imaging head 80 may be attachable to at least a part of the stage apparatus 3 (for example, at least a part of the stage 31). For example, the imaging head 80 may be attachable to at least a part of the housing 6 (for example, at least a part of the inner wall surface 611 of the wall member 61). Alternatively, the imaging head 80 may be integrated with a member that is different from the processing head 21.

In the above-described description, the control system 8 includes the mirror 82 as the optical member for guiding the workpiece light WL from the workpiece W to the imaging apparatus 81. However, an optical member that is different from the mirror 82 may be used as the optical member for guiding the workpiece light WL from the workpiece W to the imaging apparatus 81. For example, a prism may be used as the optical member for guiding the workpiece light WL from the workpiece W to the imaging apparatus 81.

In the above-described description, the control system 8 includes the mirror 82. However, the control system 8 may not include the mirror 82. Namely, the control system 8 may not include the optical member for guiding the workpiece light WL from the workpiece W to the imaging apparatus 81. In this case, the imaging apparatus 81 may optically receive the workpiece light WL without the mirror 82.

In the above description, the imaging apparatus 81 optically receives the workpiece light WL including the light emitted by the workpiece W (for example, the workpiece light WL including the light emitted by the melt pool MP formed on the workpiece W). However, an illumination apparatus may illuminate the workpiece W with illumination light, and the imaging apparatus 81 may optically receive the workpiece light WL including the illumination light through the workpiece W (for example, reflected light reflected by the workpiece W). The illumination apparatus may be provided within the control system 8. The illumination apparatus may be provided outside the control system 8.

In the above description, the imaging apparatus 81 optically receives the workpiece light WL not through the irradiation optical system 211. However, the imaging apparatus 81 may optically receive the workpiece light WL through at least a part of the irradiation optical system 211.

The imaging apparatus 81 may optically receive the workpiece light WL from at least a part of the workpiece W (especially, at least a part of the melt pool MP) through a predetermined optical filter. A filter that allows infrared light (for example, light whose wavelength is included in the range from 700 nm to 1 mm approximately) to pass therethrough, but does not allow light different from the infrared light (for example, light whose wavelength is not included in the range of 700 nm to 1 mm approximately, for example, visible light) to pass therethrough is one example of the predetermined optical filter. In this case, the workpiece image WI generated by the imaging apparatus 81 receiving the workpiece light WL may be used as an image indicating a temperature distribution of at least a part of the workpiece W (what we call a temperature map). Namely, the imaging apparatus 81 may generate the workpiece image WI that indicates the temperature distribution of at least a part of the workpiece W (namely, that is usable as the temperature map). The imaging apparatus 81 may be used as a temperature measuring apparatus to acquire information related to the temperature of at least a part of the workpiece W.

In the above-described description, the imaging apparatus 81 captures the image of at least a part of the workpiece W (especially, at least a part of the melt pool MP) to generate the workpiece image WI in which the melt pool MP appears by. However, the imaging apparatus 81 may capture the image of the melt pool MP and at least a part of the solidified metal distributed around the melt pool MP (namely, the build object, hereinafter, it is referred to as a “surrounding build object”) to generate the workpiece image WI in which the melt pool MP and the surrounding build object appear. The workpiece image WI may capture the image of the surrounding build object to generate the workpiece image WI in which the melt pool MP does not appear and the surrounding build object appears. In this case, the control apparatus 84 may control the operation of the processing system SYS based on the workpiece image WI in which the surrounding build object appears. For example, the control apparatus 84 may calculate a position (for example, a position in the Z-axis direction, which is, in effect, a height) of the surrounding build object constituting one structural layer SL based on the workpiece image WI, and control the operation of the processing system SYS to form the remaining part of the one structural layer SL based on the calculated position of the surrounding build object. For example, the control apparatus 84 may calculate the position (for example, the position in the Z-axis direction, which is, in effect, the height) of the surrounding build object constituting one structural layer SL based on the workpiece image WI, and control the operation of the processing system SYS to form other structural layer SL formed on the one structural layer SL based on the calculated position of the surrounding build object.

The imaging apparatus 81 may capture an image of an object that is different from the workpiece W. For example, the imaging apparatus 81 may capture an image of at least a part of the stage 31. For example, the imaging apparatus 81 may capture an image of at least a part of the processing head 21. For example, the imaging apparatus 81 may capture an image of at least a part of the build nozzle 212. For example, the imaging apparatus 81 may capture an image of at least a part of the build materials M supplied from the build nozzle 212. For example, the imaging apparatus 81 may capture an image of at least a part of the chamber space 63IN. In this case, the control apparatus 84 may control the operation of the processing system SYS based on the image generated by the imaging apparatus 81.

In the above-described description, the imaging apparatus 81 is contained in the housing 83. However, the imaging apparatus 81 may not be contained in the housing 83. In this case, the imaging head 80 may not include the housing 83.

In the above-described description, the imaging head 80 uses the purge gas (namely, the purge gas for cooling the imaging apparatus 81) discharged from the discharge port 834 to prevent the unnecessary substance from adhering to at least a part of the imaging head 80 and/or to remove the unnecessary substance adhering to at least a part of the imaging head 80. However, the imaging head 80 may use gas (alternatively, liquid) that is different from the purge gas discharged from the discharge port 834 to prevent the unnecessary substance from adhering to at least a part of the imaging head 80 and/or to remove the unnecessary substance adhering to at least a part of the imaging head 80. For example, the imaging head 80 may use gas supplied by a gas supply apparatus that is different from the gas supply apparatus 5 to prevent the unnecessary substance from adhering to at least a part of the imaging head 80 and/or to remove the unnecessary substance adhering to at least a part of the imaging head 80.

Alternatively, the imaging head 80 may prevent the unnecessary substance from adhering to at least a part of the imaging head 80 and/or remove the unnecessary substance adhering to at least a part of the imaging head 80 by vibrating at least a part of the imaging head 80 in addition to or instead of supplying fluid such as the purge gas to at least a part of the imaging head 80. The imaging head 80 may prevent the unnecessary substance from adhering to at least a part of the imaging head 80 and/or remove the unnecessary substance adhering to at least a part of the imaging head 80 by applying a voltage to at least a part of the imaging head 80 in addition to or instead of supplying the fluid such as the purge gas to at least a part of the imaging head 80.

In the above-described description, the control system 8 includes the control apparatus 84. However, at least a part of the function of the control apparatus 84 may be realized by the control apparatus 7 of the processing system SYS. Namely, the control apparatus 7 may perform at least a part of the operation performed by the control apparatus 84. For example, the control apparatus 7 may acquire the workpiece image WI from the control system 8, and control the operation of the processing system SYS based on the acquired workpiece image WI so that the size of the melt pool MP matches (alternatively, approaches) the target size.

In the above-described description, the processing apparatus 2 melts the build materials M by irradiating the build materials M with the processing light EL. However, the processing apparatus 2 may melt the build materials M by irradiating the build materials M with any energy beam. In this case, the processing apparatus 2 may include a beam irradiation apparatus configured to emit any energy beam in addition to or instead of the irradiation optical system 211. At least one of a charged particle beam (for example, at least one of an electron beam, an ion beam, and the like) and an electromagnetic wave is one example of any energy beam.

In the above-described description, the processing system SYS performs the additional process by the Laser Metal Deposition. However, the processing system SYS may form the three-dimensional structural object ST from the build materials M by other method for forming the three-dimensional structural object ST by irradiating the build materials M with the processing light EL (or any energy beam). Alternatively, the processing system SYS may form the three-dimensional structural object ST by any method for the additional processing that is different from the method for irradiating the build materials M with the processing light EL (or any energy beam).

As one example, the processing system SYS may form the three-dimensional structural object ST by performing the additive processing based on a Powder Bed Fusion such as a SLS (Selective Laser Sintering). Namely, the processing system SYS may form the three-dimensional structural object ST by repeating an operation of supplying powders used as the build materials M in a flatwise manner and then irradiating at least a part of the powders supplied in the flatwise manner with the processing light EL. In this case, the control system 8 may regard an aggregation of the powders supplied in the flatwise manner as the workpiece W. Namely, the control system 8 may generate the workpiece image WI by capturing an image of at least a part of the workpiece W corresponding to the aggregation of the powders supplied in the flatwise manner, and control the operation of the processing system SYS based on the workpiece image WI. Moreover, even in the case where the Powder Bed Fusion is used, the irradiation of the processing light EL forms the melt pool MP (namely, the melt pool MP formed by the molten powders) on at least a part of the powders supplied in the flatwise manner. In this case, the control system 8 may generate the workpiece image WI by capturing an image of at least a part of the melt pool MP formed in at least a part of the powders supplied in the flatwise manner, and control the operation of the processing system SYS based on the workpiece image WI.

Alternatively, the processing system SYS may perform, in addition to or instead of the additional processing, a removal processing for removing at least a part of an object by irradiating the object such as the workpiece W with the processing light EL (alternatively, any energy beam). Alternatively, the processing system SYS may, in addition to or instead of the addition and/or the removal processing, perform a marking process for forming a mark on at least a part of the object by irradiating the object such as the workpiece W with the processing light EL (alternatively, any energy beam).

At least a part of the features of each embodiment described above may be properly combined with at least another part of the features of each embodiment described above. A part of the features of each embodiment described above may not be used. Moreover, the disclosures of all publications and United States patents that are cited in each embodiment described above are incorporated in the disclosures of the present application by reference if it is legally permitted.

The present invention is allowed to be changed, if desired, without departing from the essence or spirit of the invention which can be read from the claims and the entire specification, and an imaging head, a control system, and a processing system, which involve such changes, are also intended to be within the technical scope of the present invention.

### DESCRIPTION OF REFERENCE CODES

SYS processing system
2 processing apparatus
21 processing head
22 head driving system
3 stage apparatus
31 stage
7 control apparatus
8 control system
80 imaging head
81 imaging apparatus
82 mirror
83 housing
84 control apparatus
85 input port
86 output port
W workpiece
M build material
SL structural layer
MS build surface
EA target irradiation area
MP melt pool
EL processing light
WL workpiece light
WI workpiece image

1-79. (canceled)

80. A processing system configured to process an object by irradiating the object with a processing beam,
the processing system comprising:
an irradiation optical system configured to irradiate the object with the processing beam;
an imaging apparatus configured to generate an object image by capturing an image of at least a part of a melt pool part, the melt pool part being formed on the object by an irradiation with the processing beam from the irradiation optical system;
a change apparatus configured to change a relative position of a beam irradiation position relative to the object, the beam irradiation position being irradiated with the processing beam on the object;
a characteristic information generation apparatus configured to generate, based on the object image and information related to a direction in which the relative position is changed by the change apparatus, characteristic information related to a characteristic of the melt pool part; and
a control apparatus configured to control a characteristic of the processing beam based on the characteristic information.

81. The processing system according to claim 80, wherein
the control apparatus generates the characteristic information so that a method of generating the characteristic information in a case where the relative position is changed toward a first direction is different from a method of generating the characteristic information in a case where the relative position is changed toward a second direction that is different from the first direction.

82. The processing system according to claim 81, wherein
the first direction is a direction in which the beam irradiation position moves from a first position to a second position on the object,
the second direction is a direction in which the beam irradiation position moves from the second position to the first position on the object.

83. The processing system according to claim 80, wherein
the characteristic information generation apparatus generates first characteristic information related to the characteristic of the melt pool part based on the object image, and changes the first characteristic information based on the information related to the direction in which the relative position is changed by the change apparatus to generate second characteristic information,
the control apparatus controls the characteristic of the processing beam based on the second characteristic information.

84. The processing system according to claim 80, wherein
the processing system further comprises a placement apparatus including a placement surface on which the object is placed,
the control apparatus generates the characteristic information based on angle information related to an angle of the placement surface relative to an optical axis of the irradiation optical system.

85. The processing system according to claim 84, wherein
the control apparatus generates the characteristic information so that a method of generating the characteristic information in a case where the angle of the placement surface is a first angle is different from a method of generating the characteristic information in a case where the angle of the placement surface is a second angle that is different from the first angle.

86. A processing system configured to process an object by irradiating the object with a processing beam,
the processing system comprising:
an irradiation optical system configured to irradiate the object with the processing beam;
an imaging apparatus configured to generate an object image by capturing an image of at least a part of a melt pool part, the melt pool part being formed on the object by an irradiation with the processing beam from the irradiation optical system;
a change apparatus configured to change a relative position of a beam irradiation position relative to the object, the beam irradiation position being irradiated with the processing beam on the object;
a control apparatus configured to correct the object image based on information related to a direction in which the relative position is changed by the change apparatus; and
a display apparatus configured to display the object image.

87. The processing system according to claim 86, wherein
the control apparatus corrects the object image so that a method of correcting the object image in a case where the relative position is changed toward a first direction is different from a method of correcting the object image in a case where the relative position is changed toward a second direction that is different from the first direction.

88. The processing system according to claim 87, wherein
the first direction is a direction in which the beam irradiation position moves from a first position to a second position on the object,
the second direction is a direction in which the beam irradiation position moves from the second position to the first position on the object.

89. The processing system according to claim 86, wherein
the processing system further comprises a placement apparatus including a placement surface on which the object is placed,
the control apparatus corrects the object image based on angle information related to an angle of the placement surface relative to an optical axis of the irradiation optical system.

90. The processing system according to claim 89, wherein
the control apparatus corrects the object image so that a method of correcting the object image in a case where the angle of the placement surface is a first angle is different from a method of correcting the object image in a case where the angle of the placement surface is a second angle that is different from the first angle.

91. A processing system configured to process an object by irradiating the object with a processing beam,
the processing system comprising:
an irradiation optical system configured to irradiate the object with the processing beam;
a plurality of imaging apparatuses each of which is configured to generate an object image by capturing an image of at least a part of a melt pool part, the melt pool part being formed on the object by an irradiation with the processing beam from the irradiation optical system;
a change apparatus configured to change a relative position of a beam irradiation position relative to the object, the beam irradiation position being irradiated with the processing beam on the object;
a characteristic information generation apparatus configured to generate, based on the object image generated by at least one of the plurality of imaging apparatuses and information related to a direction in which the relative position is changed by the change apparatus, characteristic information related to a characteristic of the melt pool part; and
a control apparatus configured to control a characteristic of the processing beam based on the characteristic information.

92. The processing system according to claim 91, wherein
the characteristic information generation apparatus generates the characteristic information based on a plurality of object images acquired by the plurality of imaging apparatuses and the information related to the direction in which the relative position is changed by the change apparatus.

93. The processing system according to claim 91, wherein
the characteristic information generation apparatus selects at least one of the plurality of imaging apparatuses based on the information related to the direction in which the relative position is changed by the change apparatus, and generates the characteristic information based on the object image generated by the at least one imaging apparatus selected.

94. The processing system according to claim 91, wherein
the characteristic information generation apparatus selects at least one from a plurality of object images generated by the plurality of imaging apparatuses, and generates the characteristic information based on the at least one object image selected.

95. A processing system configured to process an object by irradiating the object with a processing beam,
the processing system comprising:
an irradiation optical system configured to irradiate the object with the processing beam;
an imaging apparatus configured to generate an object image by capturing an image of at least a part of a melt pool part, the melt pool part being formed on the object by an irradiation with the processing beam from the irradiation optical system;
a first change apparatus configured to change a relative position of a beam irradiation position relative to the object, the beam irradiation position being irradiated with the processing beam on the object;
a second change apparatus configured to change a position of the imaging apparatus based on information related to a direction in which the relative position is changed by the first change apparatus;
a characteristic information generation apparatus configured to generate, based on the object image generated by the imaging apparatus at a position changed by the second change apparatus, characteristic information related to a characteristic of the melt pool part; and
a control apparatus configured to control a characteristic of the processing beam based on the characteristic information.

96. The processing system according to claim 95, wherein
the second change apparatus is configured to change the position of the imaging apparatus around a processing head including at least the irradiation optical system based on the information related to the direction in which the relative position is changed by the first change apparatus.

97. A processing system configured to process an object by irradiating the object with a processing beam,
the processing system comprising:
an irradiation optical system configured to irradiate the object with the processing beam;
a detection apparatus configured to optically receive light from at least a part of a melt pool part, the melt pool part being formed on the object by an irradiation with the processing beam from the irradiation optical system;
a characteristic information generation apparatus configured to generate, based on a detected result by the detection apparatus and processing information related to a processing of the object, characteristic information related to a characteristic of the melt pool part; and
a control apparatus configured to control a characteristic of the processing beam based on the characteristic information.

98. The processing system according to claim 97 further comprising a movement apparatus configured to move a beam irradiation position, which is irradiated with the processing beam on the object, relative to the object.
the processing information including moving direction information related to a moving direction of the beam irradiation position relative to the object.

99. The processing system according to claim 98, wherein
the characteristic information generation apparatus generates the characteristic information so that a method of generating the characteristic information in a case where the beam irradiation position moves toward a first moving direction is different from a method of generating the characteristic information in a case where the beam irradiation position moves toward a second moving direction that is different from the first moving direction.

100. The processing system according to claim 99, wherein
the first moving direction is a direction in which the beam irradiation position moves from a first position to a second position on the object,
the second moving direction is a direction in which the beam irradiation position moves from the second position to the first position on the object.

101. The processing system according to claim 99, wherein
the first moving direction intersects with the second moving direction.

102. The processing system according to claim 97 further comprising a placement apparatus including a placement surface on which the object is placed,
the processing information includes angle information related to an angle of the placement surface relative to an optical axis of the irradiation optical system.

103. The processing system according to claim 102, wherein
the characteristic information generation apparatus generates the characteristic information so that a method of generating the characteristic information in a case where the angle of the placement surface is a first angle is different from a method of generating the characteristic information in a case where the angle of the placement surface is a second angle that is different from the first angle.

104. The processing system according to claim 97, wherein
the processing information includes shape information related to a shape of the object.

105. The processing system according to claim 104, wherein
the characteristic information generation apparatus generates the characteristic information so that a method of generating the characteristic information in a case where the shape of the object is a first shape is different from a method of generating the characteristic information in a case where the shape of the object is a second shape that is different from the first shape.

106. The processing system according to claim 97, wherein
the control apparatus is a first control apparatus,
the characteristic information generation apparatus acquires the processing information from a second control apparatus configured to control the processing of the object.

107. The processing system according to claim 97, wherein
the control apparatus generates the processing information based on the detected result by the detection apparatus.

108. The processing system according to claim 107, wherein
the detected result by the detection apparatus includes an object image,
the processing system further comprises a change apparatus configured to change a relative position of a beam irradiation position relative to the object, the beam irradiation position being irradiated with the processing beam on the object;
the processing information including moving direction information related to a moving direction of the beam irradiation position relative to the object,
the characteristic information generation apparatus generates the moving direction information based on gradation of an image of the melt pool part include in the object image.

109. The processing system according to claim 97, wherein
the detection apparatus is attachable to a processing head including the irradiation optical system.

110. The processing system according to claim 97 comprising an imaging head including the detection apparatus,
the imaging apparatus being the imaging apparatus according to the imaging apparatus configured to generate the object image by capturing the image of at least the part of the melt pool part, the melt pool part being formed on the object by the irradiation with the processing beam from the irradiation optical system.

111. A processing system configured to process an object by irradiating the object with a processing beam,
the processing system comprising:
an irradiation optical system configured to irradiate the object with the processing beam;
a detection apparatus configured to optically receive light from at least a part of a melt pool part, the melt pool part being formed on the object by an irradiation with the processing beam from the irradiation optical system; and
a display apparatus configured to correct and display a detected result by the detection apparatus based on processing information related to a processing of the object.

112. A processing system configured to process an object by irradiating the object with a processing beam,
the processing system comprising:
an irradiation optical system configured to irradiate the object with the processing beam;
a plurality of detection apparatuses each of which is configured to optically receive light from at least a part of a melt pool part, the melt pool part being formed on the object by an irradiation with the processing beam from the irradiation optical system; and
a characteristic information generation apparatus configured to generate, based on a detected result by at least one of the plurality of detection apparatuses and processing information related to a processing of the object, characteristic information related to a characteristic of the melt pool part; and
a control apparatus configured to control a characteristic of the processing beam based on the characteristic information.

113. A processing system configured to process an object by irradiating the object with a processing beam,
the processing system comprising:
an irradiation optical system configured to irradiate the object with the processing beam;
a detection apparatus configured to optically receive light from at least a part of a melt pool part, the melt pool part being formed on the object by an irradiation with the processing beam from the irradiation optical system;
a change apparatus configured to change a position of the imaging apparatus based on processing information related to a processing of the object;
a characteristic information generation apparatus configured to generate, based on the detected result by the detection apparatus at a position changed by the change apparatus, characteristic information related to a characteristic of the melt pool part; and
a control apparatus configured to control a characteristic of the processing beam based on the characteristic information.

114. A processing system configured to process an object by irradiating the object with a processing beam,
the processing system comprising:
an irradiation optical system configured to irradiate the object with the processing beam;
an imaging apparatus configured to generate an object image by capturing an image of at least a part of a melt pool part, the melt pool part being formed on the object by an irradiation with the processing beam from the irradiation optical system;
a change apparatus configured to change a relative position of a beam irradiation position relative to the object, the beam irradiation position being irradiated with the processing beam on the object;
a characteristic information generation apparatus configured to generate, based on the object image and a location of a build object formed by the processing beam, characteristic information related to a characteristic of the melt pool part; and
a control apparatus configured to control a characteristic of the processing beam based on the characteristic information.

115. The processing system according to claim 114, wherein
the location of the build object is a location of a build object already formed between the imaging apparatus and the melt pool part.

116. A processing system configured to process an object by irradiating the object with a processing beam,
the processing system comprising:
an irradiation optical system configured to irradiate the object with the processing beam;
an imaging apparatus configured to generate an object image by capturing an image of at least a part of a melt pool part, the melt pool part being formed on the object by an irradiation with the processing beam from the irradiation optical system;
a change apparatus configured to change a relative position of a beam irradiation position relative to the object, the beam irradiation position being irradiated with the processing beam on the object;
a control apparatus configured to correct the object image based on a location of a build object formed by the processing beam; and
a display apparatus configured to display the object image.

117. The processing system according to claim 116, wherein
the location of the build object is a location of a build object already formed between the imaging apparatus and the melt pool part.

118. A processing system configured to process an object by irradiating the object with a processing beam,
the processing system comprising:
an irradiation optical system configured to irradiate the object with the processing beam;
a plurality of imaging apparatuses each of which is configured to generate an object image by capturing an image of at least a part of a melt pool part, the melt pool part being formed on the object by an irradiation with the processing beam from the irradiation optical system;
a change apparatus configured to change a relative position of a beam irradiation position relative to the object, the beam irradiation position being irradiated with the processing beam on the object;
a characteristic information generation apparatus configured to generate, based on the object image generated by at least one of the plurality of imaging apparatuses and a location of a build object formed by the processing beam, characteristic information related to a characteristic of the melt pool part; and
a control apparatus configured to control a characteristic of the processing beam based on the characteristic information.

119. The processing system according to claim 118, wherein
the location of the build object is a location of a build object already formed between the imaging apparatus and the melt pool part.

120. A processing method for processing an object by irradiating the object with a processing beam,
the processing method comprising:
irradiating the object with the processing beam by using an irradiation optical system;
generating an object image by using an imaging apparatus configured to capture an image of at least a part of a melt pool part, the melt pool part being formed on the object by an irradiation with the processing beam from the irradiation optical system;
changing a relative position of a beam irradiation position relative to the object by using a change apparatus, the beam irradiation position being irradiated with the processing beam on the object;
generating, based on the object image and information related to a direction in which the relative position is changed by the change apparatus, characteristic information related to a characteristic of the melt pool part; and
controlling a characteristic of the processing beam based on the characteristic information.

121. A processing method for processing an object by irradiating the object with a processing beam,
the processing method comprising:
irradiating the object with the processing beam by using an irradiation optical system;
generating an object image by using an imaging apparatus configured to capture an image of at least a part of a melt pool part, the melt pool part being formed on the object by an irradiation with the processing beam from the irradiation optical system;
changing a relative position of a beam irradiation position relative to the object by using a change apparatus, the beam irradiation position being irradiated with the processing beam on the object;
correcting the object image based on information related to a direction in which the relative position is changed by the change apparatus; and
displaying the object image.

122. A processing method for processing an object by irradiating the object with a processing beam,
the processing method comprising:
irradiating the object with the processing beam by using an irradiation optical system;
generating an object image by using at least one of a plurality of imaging apparatuses each of which is configured to capture an image of at least a part of a melt pool part, the melt pool part being formed on the object by an irradiation with the processing beam from the irradiation optical system;
changing a relative position of a beam irradiation position relative to the object by using a change apparatus, the beam irradiation position being irradiated with the processing beam on the object;
generating, based on the object image generated by at least one of the plurality of imaging apparatuses and information related to a direction in which the relative position is changed by the change apparatus, characteristic information related to a characteristic of the melt pool part; and
controlling a characteristic of the processing beam based on the characteristic information.

123. A processing method for processing an object by irradiating the object with a processing beam,
the processing method comprising:
irradiating the object with the processing beam by using an irradiation optical system;
generating an object image by using an imaging apparatus configured to capture an image of at least a part of a melt pool part, the melt pool part being formed on the object by an irradiation with the processing beam from the irradiation optical system;
changing a relative position of a beam irradiation position relative to the object by using a first change apparatus, the beam irradiation position being irradiated with the processing beam on the object;
changing a position of the imaging apparatus based on information related to a direction in which the relative position is changed by the first change apparatus by using a second change apparatus;
generating, based on the object image generated by the imaging apparatus at a position changed by the second change apparatus, characteristic information related to a characteristic of the melt pool part; and
controlling a characteristic of the processing beam based on the characteristic information.

124. A processing method for processing an object by irradiating the object with a processing beam,
the processing method comprising:
irradiating the object with the processing beam by using an irradiation optical system;
optically receiving light from at least a part of a melt pool part by using a detection apparatus, the melt pool part being formed on the object by an irradiation with the processing beam from the irradiation optical system;
generating, based on a detected result by the detection apparatus and processing information related to a processing of the object, characteristic information related to a characteristic of the melt pool part; and
controlling a characteristic of the processing beam based on the characteristic information.

125. A processing method for processing an object by irradiating the object with a processing beam,
the processing method comprising:
irradiating the object with the processing beam by using an irradiation optical system;
optically receiving light from at least a part of a melt pool part by using a detection apparatus, the melt pool part being formed on the object by an irradiation with the processing beam from the irradiation optical system; and
correcting and displaying a detected result by the detection apparatus based on processing information related to a processing of the object.

126. A processing system configured to process an object by irradiating the object with a processing beam,
the processing system comprising:
irradiating the object with the processing beam by using an irradiation optical system;
optically receiving light from at least a part of a melt pool part by using a plurality of detection apparatuses, the melt pool part being formed on the object by an irradiation with the processing beam from the irradiation optical system;
generating, based on a detected result by at least one of the plurality of detection apparatuses and processing information related to a processing of the object, characteristic information related to a characteristic of the melt pool part; and
controlling a characteristic of the processing beam based on the characteristic information.

127. A processing method for process an object by irradiating the object with a processing beam,
the processing system comprising:
irradiating the object with the processing beam by using an irradiation optical system;
optically receiving light from at least a part of a melt pool part by using a detection apparatus, the melt pool part being formed on the object by an irradiation with the processing beam from the irradiation optical system;
changing a position of the imaging apparatus based on processing information related to a processing of the object by using a change apparatus;
generating, based on the detected result by the detection apparatus at a position changed by the change apparatus, characteristic information related to a characteristic of the melt pool part; and
controlling a characteristic of the processing beam based on the characteristic information.

128. A processing method for processing an object by irradiating the object with a processing beam,
the processing method comprising:
irradiating the object with the processing beam by using an irradiation optical system;
generating an object image by using an imaging apparatus configured to capture an image of at least a part of a melt pool part, the melt pool part being formed on the object by an irradiation with the processing beam from the irradiation optical system;
changing a relative position of a beam irradiation position relative to the object by using a change apparatus, the beam irradiation position being irradiated with the processing beam on the object;
generating, based on the object image and a location of a build object formed by the processing beam, characteristic information related to a characteristic of the melt pool part; and
controlling a characteristic of the processing beam based on the characteristic information.

129. A processing method for processing an object by irradiating the object with a processing beam,
the processing method comprising:
irradiating the object with the processing beam by using an irradiation optical system;
generating an object image by using an imaging apparatus configured to capture an image of at least a part of a melt pool part, the melt pool part being formed on the object by an irradiation with the processing beam from the irradiation optical system;
changing a relative position of a beam irradiation position relative to the object by using a change apparatus, the beam irradiation position being irradiated with the processing beam on the object;
correcting the object image based on a location of a build object formed by the processing beam; and
displaying the object image.

130. A processing method for processing an object by irradiating the object with a processing beam,
the processing method comprising:
irradiating the object with the processing beam by using an irradiation optical system;
generating an object image by using at least one of a plurality of imaging apparatuses each of which is configured to capture an image of at least a part of a melt pool part, the melt pool part being formed on the object by an irradiation with the processing beam from the irradiation optical system;
changing a relative position of a beam irradiation position relative to the object by using a change apparatus, the beam irradiation position being irradiated with the processing beam on the object;
generating, based on the object image generated by at least one of the plurality of imaging apparatuses and a location of a build object formed by the processing beam, characteristic information related to a characteristic of the melt pool part; and
controlling a characteristic of the processing beam based on the characteristic information.
